(19) United States
(12) Patent Application Publication
(10) Pub. No.: US 2002/0123994 A1
(43) Pub. Date: Sep. 5, 2002

(54) System for fulfilling an information need using extended matching techniques

(76) Inventors: Yves Schabes, Newton, MA (US); Emmanuel Roche, Belmont, MA (US)

Correspondence Address: Choate, Hall & Stewart, Exchange Place, 53 State Street, Boston, MA, 02109, US

(21) Appl. No.: 10/004,952

(22) Filed: Dec. 5, 2001

Related U.S. Application Data
(63) Continuation-in-part of application No. 09/559,223, filed on Apr. 26, 2000.
(60) Provisional application No. 60/251,608, filed on Dec. 5, 2000.

(51) Int. Cl. G06F 7/00

(52) U.S. Cl. 707/5

(57) ABSTRACT

The invention offers new approaches to fulfilling an information need, in particular to finding a result for a query based on a large body of information such as a collection of documents. The invention accepts a query containing an unspecified portion that expresses the information need. The invention locates matches for the query within a body of information and returns the matches or portions thereof in addition to or instead of identifiers for documents in which the matches are found. The invention allows placement of term ordering restrictions, and allows intervening words between the search terms as they appear in the searched documents or contexts. The invention ranks the matches in order to provide the most relevant information. One preferred method of ranking considers the number of instances of a match among a plurality of documents. The invention further defines a new type of index that includes contexts in which terms occur and provides methods of searching such indices to fulfill an information need.

The present application is a continuation in part of co-pending U.S. patent application Ser. No. 09/559,223 entitled “System for Fulfilling an Information Need”, filed Apr. 26, 2000. The present application claims the benefit of U.S. Provisional Application No. 60/251,608 entitled “System for Fulfilling an Information Need Using Extended Matching Technique”, filed Dec. 5, 2000.

### FIELD OF THE INENTION

The present invention relates to an apparatus and accompanying methods for a system that accepts a query and fulfills an information need expressed by the query based on a body of information such as a collection of documents. The invention has particular utility in connection with text indexing and retrieval systems, such as retrieval of information from the World Wide Web.

### BACKGROUND OF THE INVENTION

With the rapid growth in the amount of information available in the form of documents stored in databases has come an increased need to efficiently extract information relevant to a specific need. Traditional searching methods search and retrieve documents according to the words in a given input query. Search engines allow users to find documents containing one or more words or phrases, often referred to as keywords, found in the input query and return a list of relevant documents for the input query. For instance, with traditional search and retrieval methods, the input query

Clinton congress

returns the most relevant documents containing the word Clinton or the word congress or both words. Search engines may also permit the formulation of Boolean queries, which allow words in the query to be combined using logical operations such as AND, OR, and NOT. For example, using a traditional Boolean search engine, the query

Clinton AND congress AND (NOT Hillary)

selects documents that contain the word Clinton and the word congress but that do not contain the word Hillary.

Another feature often found in queries used with traditional search engines is the ability to trigger a search for phrases in documents. For example the query

“Bill Clinton”

retrieves documents that contain the exact phrase Bill Clinton while rejecting documents that contain the word Bill and/or the word Clinton separately. Examples of search engines offering these capabilities are search engines used with the World Wide Web such as Alta Vista™, Lycos™, Inktomi™, InfoSeek™, NorthernLight™, HotBot™, MSN Search™, Google™ and Yahoo!™. Additional search engines include those used for searching documents found in databases, digital libraries or other information sources such as InfoSeek UltraSeek Server™.

The result of a search using search engines such as those mentioned above is a list of relevant documents, generally displayed in some order, for example, from the most relevant document to the least relevant document. To present documents in an order, search engines rank the documents according to some metric. Typically, the ranking will first show documents containing the highest number of keywords. For example, FIG. 1 shows the result of a search on HotBot™ (http://www.hotbot.com) for the query presidential candidates. FIG. 1 shows the first 10 documents ranked from the most relevant document to the least relevant document. Each of the results consists of a description of a document. Such description includes the title of the document, a description of the document, and its Internet Uniform Resource Locator (URL).

Many conventional search engines, and World Wide Web search engines in particular, suffer from a drawback in that they only allow for a fully specified query and do not allow for queries where a portion can be wholly or partly unspecified. For example, when the phrase Alexander Bell is searched using traditional technologies, all documents containing the phrase Alexander Bell will be returned. However, documents which contain the phrase Alexander Graham Bell will not be returned because the phrase Alexander Graham Bell is different than the phrase Alexander Bell specified in the query. Similarly, if one employs the Boolean query Alexander AND Bell to search for documents, the result of the search will include documents that contain the words Alexander and Bell anywhere in the document, regardless of where they occur in relation to each other. Thus the search will return many documents that do not contain the information sought by a user. For example, the search will return documents that contain Alexander Heard and Packard Bell since such documents contain the words Alexander and Bell. Such documents are unlikely to be relevant to a search for documents about Alexander Bell. With most conventional search engines, as described above, it is not possible to search for the phrase Alexander followed by any word and followed by Bell, e.g., Alexander_Bell. Such a query should match documents that contain the string Alexander Graham Bell.

To provide more flexibility in searching, some search and query systems offer proximity operators. These operators allow a user to request that the words in the query be within a certain distance of each other in a document. For example, a query using the NEAR operator (a feature of the Alta Vista™ search engine) retrieves documents that contain the search terms within 10 words of each other. Thus a user seeking to learn the middle name of Alexander Bell could enter a query such as

Alexander NEAR Bell

This query will retrieve documents containing any of the strings Alexander Bell, Alexander Graham Bell, Alexander Heard and Packard Bell, Alexander heard the bell, Alexander Frederick Edward Bell, among others. Note that these strings contain several types of words such as verbs, determiners, etc., in addition to names. Thus the query results still suffer from a lack of specificity. Certain search and query systems such as DIALOG® allow a further refinement in that the user may request that the search terms occur within a given distance of each other within a document. For example, the (3W) operator requests that the search terms occur within three words of each other. This option offers more control over the query results but still retrieves documents based on the positional relationship of the search terms within the document, regardless of the actual content of the intervening text. Although reducing the number of intervening terms may reduce the number of irrelevant documents retrieved, in the case of many queries it may also result in failure to retrieve relevant documents.

Furthermore, the query structure available in traditional search and query systems is not conducive to searching for information that may lie outside the bounds of the search terms. For example, a user who has forgotten the last name of George Washington Carver (an agricultural chemist and holder of U.S. Pat. Nos. 1,522,176 and 1,541,478) could conduct a search using the specified terms George and Washington. While yielding hundreds of documents related to George Washington, such a search would be unlikely to provide the desired information about George Washington Carver. There is no way for a user to include both fully specified terms such as George and Washington in the query in addition to clearly indicating a desire to retrieve a particular unspecified element, such as a term that follows the specified terms.

Another area in which conventional searching systems are limited is in their ability to search effectively for phrases. In prior art systems, identifying documents that contain phrases requires either indexing the phrases as single terms or identifying documents that contain the individual terms, locating the terms, and determining their positional relationship to each other. Indexing phrases as single terms is generally limited to phrases of two or at most three terms, and it is not feasible to index all or even a majority of phrases. Also, in order to provide information about the terms adjacent to or surrounding a phrase of interest, prior art systems must access the document that contains the phrase.

In addition to the limitations discussed above, conventional searching systems suffer from a major drawback in that they typically provide only names, titles, URLs, file names, or identifiers of documents in response to a query. For example, conventional Web search engines provide only the name of a document containing a search term, together with a uniform resource locator (URL) for that document. The user must then access and examine the document in order to locate the desired information. Especially in the case of a large database such as the World Wide Web, this can be a significant burden, particularly if the query structure does not permit the user to accurately indicate what information is needed. Even in the case of those search engines that return a passage of text that includes the query terms in addition to returning an identifier for the document in which the text appears, the user may still need to scan through many such passages to locate desired information. Since it is not possible to place any restrictions on the text between or around the search terms, the user is likely to encounter a great deal of material that is irrelevant to the actual information desired. Furthermore, results are returned on a document by document basis. The order of the documents is frequently based on the number of occurrences of the search terms within each document. Traditional search and query systems do not perform an assessment of the results of the query across multiple documents. Thus the results provided by traditional search and query systems do not consider the information content of the database as a whole.

There exists a significant need for a search and query system that overcomes the various limitations described above. In particular, there is a need for a system that accepts a partially unspecified query and returns the actual text that matches the query, in addition to or instead of the list of documents that contain a match for the specified portion of the query. For example, there is a need for a search system that accepts the partially unspecified query Alexander_Bell and returns the middle name Graham or the string Alexander Graham Bell instead of or in addition to the list of documents which match the partially unspecified query. As another example, there is a need for a search system that accepts the partially unspecified query Microsoft Windows_, and returns the strings Microsoft Windows 95, Microsoft Windows 98, Microsoft Windows NT, and Microsoft Windows 2000 in addition to or instead of the list of documents that match the query. Furthermore, there is a need for a search and query system that accepts a partially unspecified query and allows the user to accurately indicate a specific information need by placing restrictions on the unspecified portion of the query. In addition, there is a need for an innovative approach to the tasks of searching for phrases and providing information about terms adjacent to the phrases.

It would also be beneficial if a search and query system meeting the needs described above also offered the ability to wholly or partially specify the ordering of terms as they appear within the text that may be considered matches for the partially unspecified query. Additionally, it is desirable that such a system not disregard potential matching strings simply because terms not matching the fully or partially specified terms of the query intervene between the fully or partially specified terms of the query.

Finally, when there are multiple different strings that match the partially unspecified query, there is a need to present those strings in a relevant order. In particular, there is a need for a search and query system that ranks the results based not on the contents of the individual documents that contain the search terms, but rather on the content of multiple documents. In other words, there is a need for a search system that considers the query in relation to the information available within a large body of information such as a large collection of documents rather than in relation to single documents.

### SUMMARY OF THE INVENTION

The present invention provides a system and method for fulfilling an information need using an extended matching technique. The invention extends the matching capabilities presented in Applicants' co-pending U.S. patent application entitled “System for Fulfilling an Information Need” (hereinafter “the Information Need application”). The extended matching technique processes queries containing a partially unspecified portion. The technique allows for the identification of matches in documents in which the matching terms need not appear in the same relative order as in the query and in which there may be intervening words between the matching terms. Such queries are referred to as unordered queries. The technique also allows for queries in which the order of some or all of the terms is specified, referred to as ordered queries. Several different techniques that may be employed in implementation of the invention are presented. One implementation is based on the use of contexts as described in the Information Need application. A second implementation encodes a partially or wholly unspecified query using alternative data structures such as trees, graphs or finite state machines. Thus, the description of the invention below, in which finite state transducers (FSTs) represent all possible orderings of the encoded query, are simply examples of preferred embodiments and are not intended in any way to be limiting. Weights associated with each arc of the FST may be used to accumulate a score for a match that reflects the difference(s) between the query and the matching context. The query is additionally converted into a Boolean expression to optimize search efficiency. Another aspect of the invention employs novel index data structures including index data structures that identify terms within documents that satisfy restrictions associated with partially unspecified terms of the query. Matches for the query and/or the partially unspecified terms of the query are identified by intersecting lists of documents.

The present invention addresses the needs described above by providing new approaches to the task of gathering information related to an information need based on a large body of information. Thus, in broad terms, the invention is a system (e.g., a method, apparatus, and computer-executable process steps) for fulfilling an information need. The invention identifies information to provide a result for a query containing an unspecified portion in addition to or instead of a specified portion. The unspecified portion of the query corresponds to an information need, for example, an item of information sought by a user. For example, the system allows a user to enter a query such as_Gates, and receive back matches including the name Bill. In addition, rather than merely including defined terms that are related to an information need, a query containing an unspecified portion according to the present invention can more explicitly express the need. In particular, the query structure of the present invention facilitates accurate expression of the information need by permitting restrictions on the unspecified portion as described below. The invention then addresses the need by identifying matches for the query within documents. In some embodiments, the invention allows for specification of tightened or relaxed ordering of terms within text strings considered matching the query, which will be referred to as ordered and unordered queries, respectively. Additionally, some embodiments of the invention allow acceptance of text strings as matches despite the presence of terms intervening among the terms of the query. Instead of returning only document locations and/or identifiers and possibly document summaries as results for the query, the present invention returns the matches themselves or relevant portions of the matches (e.g., portions that correspond to the unspecified portion of the query). Document locations and/or identifiers and other information can optionally be returned in addition to the matches, and the documents themselves can be ranked. Furthermore, in preferred embodiments the invention ranks the results based on the occurrence of matches across a plurality of documents rather than on a document by document basis. The invention has particular utility in obtaining results for queries by searching documents on the World Wide Web.

In one aspect, the invention is a system (i.e., a method, apparatus, and computer-executable process steps) for obtaining a result for a query that contains one or more unspecified portions. The unspecified portion can be wholly unspecified, as in the query Alexander_Bell. In certain preferred embodiments of the invention the unspecified portion is only partially unspecified, in which case it includes a restriction that defines a category of terms that are acceptable matches for the unspecified portion. The restriction may indicate that an unspecified portion of a query must meet a category criterion, a morphological or syntactic criterion, or a criterion defined by a computer program. For example, the restriction may indicate that an unspecified portion of a query must be a name, date, noun phrase, etc. Thus the query Microsoft_[NUM] includes a partially unspecified portion with a restriction indicating that only phrases in which the word Microsoft is followed by a number should be identified as a valid match. The query Microsoft_[NP] includes a partially unspecified portion with a restriction indicating that only phrases in which the word Microsoft is followed by a noun phrase (e.g., Windows operating system, computer corporation, etc.) should be identified as valid matches. As indicated by this example, although according to the query syntax a partially unspecified portion is indicated by a single underscore character (in some cases followed by an associated restriction), the matching text may comprise multiple terms. For descriptive purposes the convention that a partially unspecified term is represented by an underscore character followed by a restriction will be adopted herein. For the sake of clarity the underscore and its associated restriction are generally separated by a blank within this document.

The system receives a query containing an unspecified portion. The system identifies matches for the query within a body of information. Typically the body of information comprises a body of text, which may be organized in the form of discrete documents. The invention preferably identifies a plurality of matches for the query and ranks the identified matches. The ranking is based on any of a variety of criteria. In preferred embodiments of the invention the ranking reflects the number of times an instance of the match is identified within the portion of the body of information that is searched. The matches are output, preferably in an order based on the ranking, to provide a result for the query. Additional information, such as a score for the match, can also be provided as part of the results. In certain embodiments of the invention rather than outputting the entire text of a match, only that portion of the match that corresponds to an unspecified portion of the query is output.

In certain embodiments of the invention a result for a query containing an unspecified portion is obtained based on the contents of documents in a database. In these embodiments, the system stores, in memory, an index identifying documents that contain terms. The index may also store the locations of the documents within a database (e.g., the URLs of the documents when the database comprises pages on the World Wide Web). In certain preferred embodiments of the invention the index also stores information identifying terms that satisfy restrictions and/or computer programs that define restrictions. For example, the index may store terms that meet the restriction [PROPER NAME], terms that meet the restriction [COUNTRY], terms that meet the restriction [NP] (noun phrase), terms that meet the restriction [BASEBALL PLAYER] among others.

In one embodiment of the invention, when the system receives a query containing an unspecified portion, it converts the query into a Boolean expression and applies searching techniques to identify documents and preanalyzed contexts (text strings) from the index that satisfy the Boolean expression, e.g., containing some or all of the terms in the query. The system then locates matches for the query by converting the query to a FST that is matched against the content of the identified contexts through the Boolean matching process. When the query includes an unspecified portion containing a restriction, the system uses the information identifying terms that satisfy the particular restriction and/or the computer programs that define restrictions to determine whether a potential match is indeed a match. In certain preferred embodiments, this information has already been encoded into the preanalyzed contexts in the form of weighted arcs in a finite state automata representation of the preanalyzed context.

In certain embodiments, the invention assigns a penalty or cost to a particular match reflecting the dissimilarity of term ordering between the query and the potentially matching context. In other embodiments, such a penalty or cost is assigned if intervening terms appear between the query terms as they appear in a potentially matching context. A threshold penalty or cost may be established above which a potentially matching context may be rejected.

In certain embodiments of the invention, the system provides (i.e., outputs) some or all of the matches as a result for the query. Alternatively, the result may include a portion of a match that corresponds to a wholly or partially unspecified portion of the query rather than the entire match. In addition to providing matches (or portions thereof) as a result for the query, in certain embodiments of the invention the result also includes identifiers and/or locations for the documents containing the matches and, optionally, additional information about the match. The result can be provided to a user by displaying the matches or portions thereof, the document identifiers or locations, etc., in an appropriate format on a display screen. If a particular match appears in multiple documents, the documents in which that match is found may themselves be ranked, e.g., based on the number of times an instance of the match is located within a document.

As the system locates matches it preferably accumulates information related to the matches and, optionally, information related to the documents that contain the matches. In certain embodiments of the invention a located match is assigned a score, and the match is stored in a match list together with the score. The score preferably reflects the number of times an instance of the match is identified among a plurality of documents. In certain embodiments of the invention, the system ranks the located matches. The ranking is preferably based on the content of a plurality of documents, e.g., the number of times an instance of the match is located among a plurality of documents. Additional information that is accumulated as the matches are located may also be used to assign a score to a match and/or to rank the matches. In certain preferred embodiments of the invention, the system outputs the results of the query in an order based on the ranking.

Prior to the processing of any queries, the system stores information (e.g., in one or more indices) identifying a set of contexts for a term. The contexts correspond to linguistically analyzed text strings containing the given term, the strings occurring within documents in the database. In certain embodiments of the invention, the contexts are stored as finite state automata. Indications of which contexts are associated with a given document, and information relating to restrictions that are satisfied by given contexts may also be stored. The system locates matches for the query within the set of contexts rather than searching for matches within the documents themselves, thereby providing an opportunity for faster and more efficient processing of the query.

In certain preferred embodiments of the invention, as the system locates matches among the contexts it also accumulates information related to the matches. A located match is assigned a score, and the match is stored in a match list together with the score. In certain embodiments of the invention the score reflects the number of occurrences of the match among a plurality of contexts (and therefore among a plurality of documents). The system ranks the located matches, preferably based on the content of a plurality of contexts (and therefore also on the content of a plurality of documents). For example, the ranking can be based on the number of times an instance of a match is found across a plurality of contexts. Additional information that is accumulated as the matches are located may also be used to rank the matches, such as the query term ordering and intervening term information described above. The system provides (i.e., outputs) the results of the query, preferably in an order based on the ranking. In certain embodiments of the invention the results include identifiers and/or locations of the documents containing contexts that match the query and, optionally, additional information about the matches and/or documents.

In another aspect, the invention is a system for fulfilling an information need by searching contexts for one or more terms that appear in a query. The contexts are obtained from a body of information such as a collection of documents. The query may consist of fully specified terms or partially and/or unspecified terms. The results for the query can comprise contexts themselves or portions thereof, in addition to or instead of document identifiers or locations. A feature of the invention in this aspect is that rather than searching documents containing query terms, the system searches contexts that contain the terms.

In another aspect, the invention is a system for creating an index identifying contexts for terms, the contexts occurring within documents in a database. The system first selects a document in the database and then selects a term within the document. The system identifies contexts for the term within the document, the contexts corresponding to strings within the document that contain the term. The system further stores information identifying the document and associating the document identifier with the context. Thus, a given term may have multiple contexts within several document For a given term, in addition to storing the contexts and associated document identifiers, the system stores information indicating the number of documents that contain the term and, for each document, the number of contexts containing the term. After identifying some, or preferably all, of the contexts for the term within a given document, the system selects another term within the document and identifies contexts for that term within the document. The context identification process continues for the selected document until a set of contexts has been identified for a plurality of terms (e.g., all the terms in the document or all the terms excluding determiners, etc.). The entire process is repeated for a plurality of documents in the database. In addition to storing the contexts themselves, in certain embodiments of the invention information about the contexts is also stored. Such information includes factors that may provide an indication of the significance of the context, such as the position of the context within the document, the age of the document in which the context appears, or the co-occurrence of certain words within the context. In certain embodiments of the invention the contexts are stored as finite state automata. Information about a context is stored within the finite state automaton that represents the context.

In certain embodiments of the system for creating an index identifying contexts for terms, the system does not store information identifying the document in which a context appears. The system selects a document in the database and then selects a term within the document. The system identifies contexts for the term within the document, the contexts corresponding to strings within the document that contain the term. Each identified context is added to a set of contexts for that term. The context identification process continues for the selected document until a set of contexts has been identified for a plurality of terms in the document. The entire process is repeated for a plurality of documents in the database. For a given term, in addition to storing the contexts and associated document identifiers, the system stores information indicating the number of documents that contain the term. In certain embodiments of the invention the contexts are stored as finite state automata. Such information includes factors that may provide an indication of the significance of the context, such as the position of the context within the document, the age of the document in which the context appears, or the co-occurrence of certain words within the context. In certain embodiments of the invention the contexts are stored as finite state automata. Information about a context is stored within the finite state automaton that represents the context.

In another aspect, the invention is a data structure identifying subsets of preanalyzed contexts for terms, each subset of contexts occurring within a document in a database. The data structure includes a term array, a document array, and a context array. For a given term, the context array contains subsets of preanalyzed contexts, each subset consisting of preanalyzed contexts in which the term occurs within a document. The context array may also include, for each subset of contexts, information indicating the number of contexts in the subset. For a given term, the document array includes information identifying the documents within which the term appears. For a given document containing a given term, when the context array contains a subset of contexts corresponding to that term and document, the document array contains information for accessing, within the context array, the subset of contexts for the given term and document. For a given term, the term array includes the number of documents containing the term and information for accessing, within the document array, the document identifiers for documents that contain the term. In certain embodiments of the invention the contexts are stored as finite state automata.

In another aspect, the invention is a data structure identifying contexts for terms, the contexts occurring within documents in a database. The data structure includes a term array and a context array. For a given term, the context array contains a set of contexts in which the term occurs in documents in the database. The term array contains the number of contexts stored in the context array for the given term and also contains information for accessing the set of contexts for that term within the context array. In certain embodiments of the invention the contexts are stored as finite state automata.

### BRIEF DESCRIPTION OF THE DRAWINGS

FIG. 1 is an example of a search result obtained using a traditional search system.

FIG. 2 shows a representative embodiment of a networked computer system that may be used to implement the present invention.

FIG. 3 is a perspective view of a query server of in the present invention.

FIG. 4 shows the architecture of the query server shown in FIG. 2.

FIG. 5 shows a portion of the architecture of the indexing computer shown in FIG. 2.

FIG. 6 shows an example of search results obtained in accordance with the Information Need invention.

FIG. 7 shows an example of search results for the queries Microsoft Windows_and_{—}2000 in accordance with the Information Need invention.

FIG. 8 shows an example of search results for the query Microsoft_{—}2000 in accordance with the Information Need inventions.

FIG. 9 shows an example of search results for the query Microsoft Windows_[NUM] in which the unspecified portion of the query is restricted to match only a number.

FIG. 10 shows an example of search results for the query Windows_[NUM]_in which the unspecified portion includes a partially unspecified term and a wholly unspecified term.

FIG. 11 shows an example of search results for the query Alexander Graham Bell invented the_[NP] in which the unspecified portion of the query is restricted to match only a noun phrase.

FIG. 12 shows a screen dump illustrating results for the query_[WHO] French President

FIG. 13 shows a screen dump illustrating results for the query_[WHEN] born Benjamin Franklin

FIG. 14 shows a screen dump illustrating results for the query_[CITY] born Benjamin Franklin

FIG. 15 shows an alternative user interface that allows a user to select the question word Where to express an information need.

FIG. 16 shows an alternative user interface that allows a user to select the question word Where to express an information need.

FIG. 17 is an illustration of data structures according to the present inventtion.

FIG. 18 is a flow diagram of an embodiment of the extended matching process.

FIG. 19 is a flow diagram of an embodiment of the conversion process for converting a query into a Boolean expression.

FIGS. 20A-F illustrations of finite state machine representations of example query_[NHUM] invent and_invent in any order.

FIGS. 21A-B shows screen dumps of alternative user interfaces for the present invention.

FIG. 22 shows a screen dump of search results for the query win U.S. open on the GOOGLE™ system.

FIG. 23 is a flow diagram for a process that stores contexts for terms within an index.

FIG. 24 is an illustration of a finite state automaton for Alexander Graham Bell.

FIG. 25 is an illustration of a finite state automaton for Alexander Bell invented the telephone.

FIG. 26 is a flow diagram of a process for generating FSA representations of text strings.

FIG. 27 is a flow diagram of an alternate embodiment of the extended matching process.

### DETAILED DESCRIPTION OF CERTAIN EMBODIMENTS

Preferred embodiments of the invention will now be described with reference to the accompanying drawings. As stated above, the present invention builds on the systems and methods described in Applicants' Information Need application, U.S. Ser. No. 09/559,223, filed Apr. 26, 2000. The contents of that application, the contents of all references mentioned therein, and the contents of all references mentioned within this document are incorporated herein by reference. The extended matching technique described herein expands the repertoire of methods available for identifying a match for a partially unspecified query beyond those described in the Information Need application. Presented below is a description of the Information Need invention, followed by a description of the extended matching techniques which are part of the present invention.

I. System Configurations

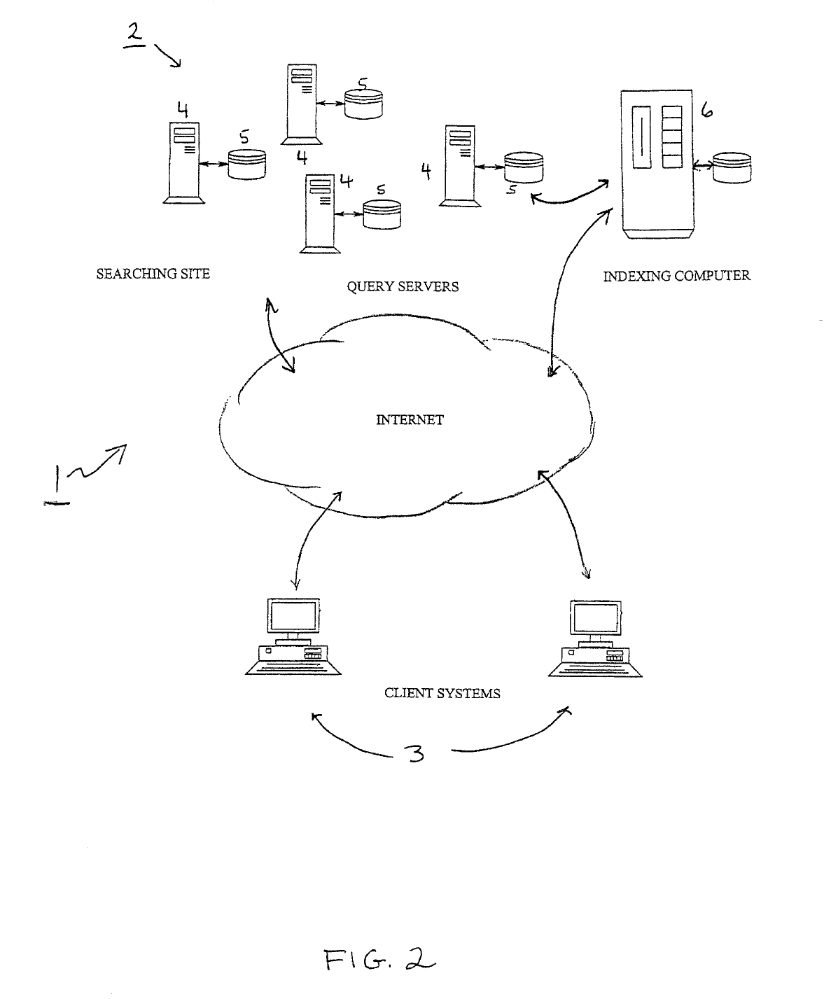

FIG. 2 shows a representative embodiment of a networked computer system 1 that may be used to implement the present invention. A searching site 2 is logically connected, via a network such as the Internet, to one or more client computer systems 3. Client computer system 3 can comprise any available computer but is typically a personal computer equipped with a processor, memory, display, keyboard, mouse, storage devices, and appropriate interfaces for these components. Client system 3 accepts a user-generated query and transmits the query to searching site 2. Preferably client system 3 operates a Web browser, and the query is entered into the Web browser that transmits the query to searching site 2. Searching site 2 may include one or more query servers 4, which may be logically connected to one another for example through a local area network, intranet, or the like. Query servers 4 may be connected to one or more peripheral storage devices 5. Searching site 2 also includes indexing computer 6, which is preferably also logically linked to the network and to query server(s) 4. In preferred embodiments of the invention indexing computer 6 collects documents and analyzes the documents to produce an index, as described in more detail below. Although for descriptive purposes the indexing and query fulfillment aspects of the invention are described as taking place on separate machines, the same machine can serve both functions.

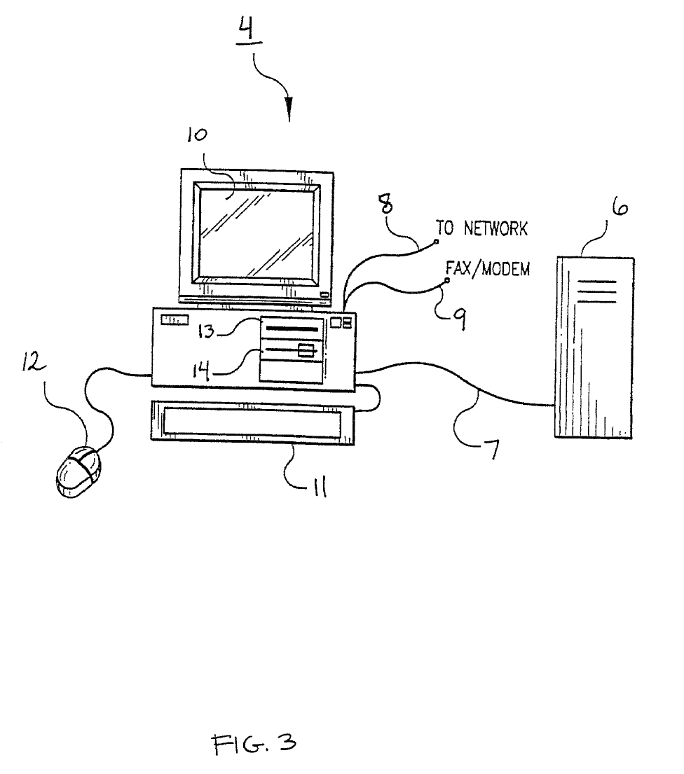

A representative embodiment of query server 4 is shown in FIG. 3. Query server includes a local area network connection 7 for interfacing to additional query server(s), indexing computer(s) 6, peripheral storage device(s), etc. Query server 4 also includes a general network connection 8 for interfacing to a network such as the Internet, and fax/modem connection 9 for interfacing with other remote sources. In certain embodiments of the invention query server 4 includes display screen 10 for displaying information, keyboard 11 for inputting text and user commands, mouse 12 for positioning a cursor on display screen 10 and for inputting user commands, disk drive 13 for reading from and writing to floppy disks installed therein, and CD-ROM drive 14 for accessing information stored on CD-ROM. As mentioned above, query server 4 may also have one or more peripheral storage devices attached thereto.

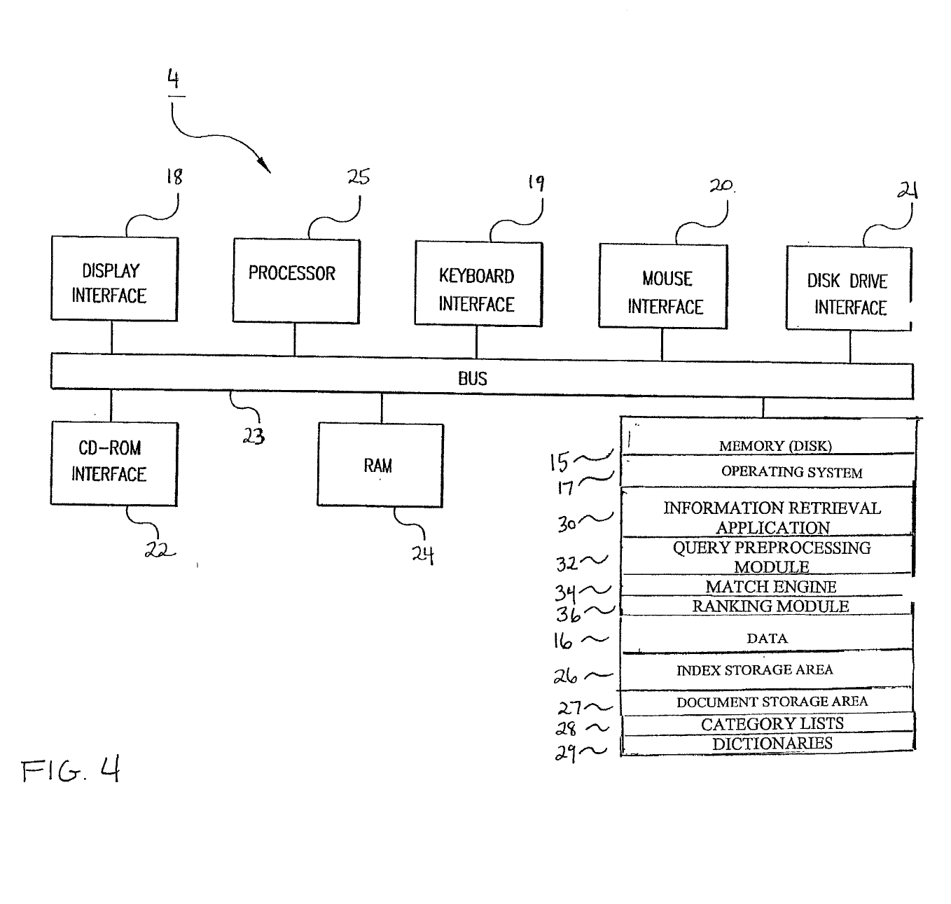

FIG. 4 shows the internal structure of query server 4. As shown in FIG. 4, query server 4 includes memory 15, which comprises one or more computer-readable media, such as a computer hard disk. Typically memory 15 comprises a hard disk, but it may comprise other storage media such as floppy disks, CD-ROMs or read/write CDs, or other devices known in the art. Memory 15 stores data 16, applications, and an operating system 17. Also included in certain embodiments of query server 4 are display interface 18, keyboard interface 19, mouse interface 20, disk drive interface 21, CD-ROM drive interface 22, computer bus 23, RAM 24, and processor 25. Processor 25 preferably comprises a microprocessor or the like for executing applications out of RAM 24. As noted above, these applications may be stored in memory 15 or, alternatively, on a floppy disk in disk drive 13 or a CD-ROM in CD-ROM drive 14. In this regard, processor 25 accesses applications (or other data) stored on a floppy disk via disk drive interface 21 and accesses applications (or other data) stored on a CD-ROM via CD-ROM drive interface 22.

Application execution and other tasks of query server 4 may be controlled and/or altered using keyboard 11 or mouse 12, commands from which are transmitted to processor 25 via keyboard interface 19 and mouse interface 20, respectively. Such tasks may also be controlled via commands transmitted to query server 4 via network connections 7, 8, or 9. Output results from some applications running on query server 4 may be processed by display interface 18 and then displayed to a user on display 10. To this end, display interface 18 preferably comprises a display processor for forming images based on data provided by processor 25 over computer bus 23, and for outputting those images to display 10. Certain applications may provide outputs to network interfaces 7, 8, or 9. In preferred embodiments of the invention query server 4 also includes index storage area 26 and document storage area 27. In this regard it is noted that query server 4 optionally includes peripheral storage devices 5 that may include index and/or document storage areas 26 and 27. In certain embodiments of the invention data stored in memory 15 includes category lists 28, dictionaries 29, and index or indices 50 which are discussed further below.

Applications stored in memory 15 include information retrieval application 30. Information retrieval application 30 includes query module 32, match engine 34, and ranking module 36, which together comprise computer-executable process steps to accept a query and satisfy an information need expressed by the query based on a body of information such as a collection of documents in a database. Briefly, information retrieval application 30 receives a query and identifies matches for the query that occur within the body of information. In preferred embodiments of the invention as the application locates a match it gathers information about the match, assigns a score to the match, and stores the match and the associated score. Preferably the score is based on the number of times an instance of the match is identified within the body of information. In preferred embodiments of the invention information retrieval application 30 uses the score to rank the matches. The results for the query comprise the matches themselves or portions thereof. In addition, the results may include a list of documents in which a given match is found. Additional information such as the location of the documents and/or other information about the matches or the documents may be provided in the results. A detailed description of these process steps is provided below.

As noted above, in general a user-generated query is entered into a client system and transmitted to the searching site 2. However, in certain embodiments of the invention queries may also be entered directly into query server 4 or may be generated by an application program stored either on the query server or elsewhere. In a preferred embodiment of the invention, the body of information searched by information retrieval application 30 comprises a collection of Web pages. However, it is noted that the invention is not limited to searching Web documents and, in fact, can be used in conjunction with a variety of different types of documents and databases. Moreover, it is noted that although the invention will be described with respect to searching based on text/character strings, the invention is not limited to this either. That is, the invention may also be used to provide results for queries based on images or other types of data from any type of database.

In addition to information retrieval application 30, applications stored in memory 15 may include results page generator 38, which comprises computer-executable process steps to format and output search results in a variety of ways. In various embodiments of the invention, information obtained by information retrieval application 30 in response to the query can be provided to another application stored either on the query server or a connected computer, to a user of query server 4, or to a user at a remote location via network connection 7.

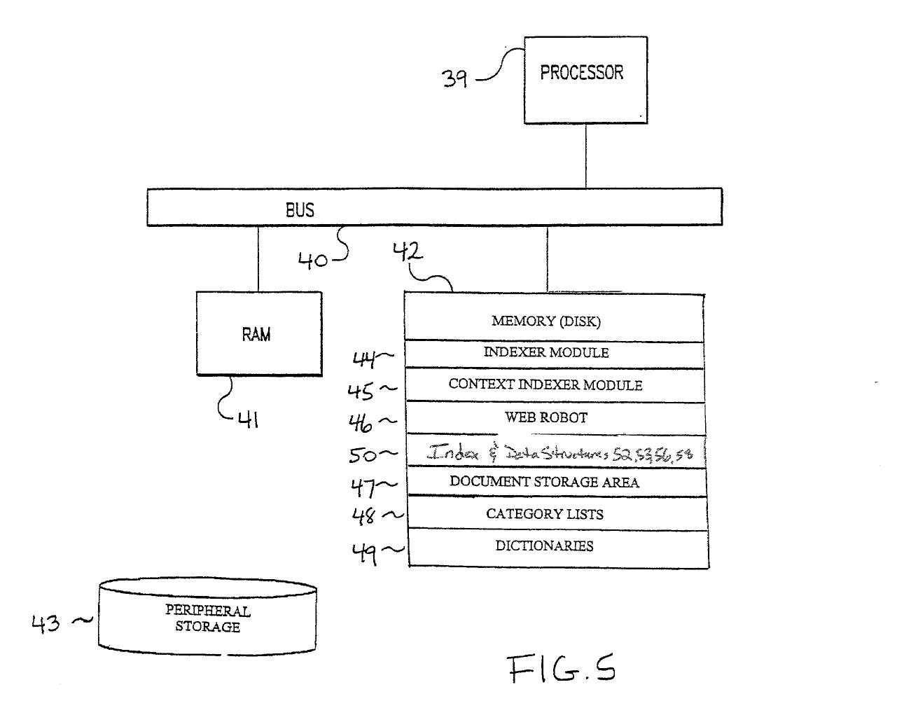

FIG. 5 shows a portion of the internal structure of indexing computer 6. Indexing computer 6 comprises a processor 39, bus 40, RAM 41, memory 42, and optionally peripheral storage 43. Memory 42 comprises one or more computer-readable media such as a hard disk. Indexing computer 6 preferably includes a general network connection (not shown) for interfacing to a network such as the Internet and also a local area network connection (not shown) for interfacing to query servers 4. Applications stored in memory 42 include indexer module 44, which comprises computer-executable process steps to construct an index identifying documents containing terms. In certain embodiments of the invention, applications include context indexer module 45, which comprises computer-executable process steps to store contexts for terms. Other applications may include Web robot 46. In certain embodiments of the invention Web pages are used as a source of documents to be indexed by indexer module 44 and/or context indexer module 45. In this case Web robot 46 may periodically search the Web and retrieve Web pages. Web robot 46 can comprise any Web robot, of which a number are commercially available. Memory 42 can include document storage area 47, although of course documents can also be stored on peripheral storage 43. Data stored in memory 43 preferably includes category lists 48 and dictionaries 49. In preferred embodiments of the invention these are identical to category lists 28 and dictionaries 29 stored on query server(s) 4. In certain embodiments of the invention query servers 4 and indexing computer 6 access the same category lists and dictionaries. Index or indices 50 generated by indexing computer 6 are also preferably stored in memory 43. Although a single indexing computer has been described, it is noted that in practice the tasks associated with building an index are preferably distributed among multiple indexing computers.

In certain embodiments of the invention, indexer module 44 is based upon the indexer described in “The SMART Retrieval System: Experiments in Automatic Document Processing” by Gerald Salton (Prentice-Hall, Inc. (1971)) and “A Theory of Indexing” also by Gerald Salton (J. W. Arrowsmith, Ltd. (1975)). The contents of these two documents are hereby incorporated by reference into the subject application as if set forth herein in full. Indexer module 44 and context indexer module 46 are described in more detail below. Indices generated by indexer module 44 and/or context indexer module 46 may be copied to query servers 4 or to any storage device to which query servers 4 have access as may the documents themselves or portions thereof, either separately or as part of the index. It is noted that the foregoing description is intended by way of example and is not intended to be limiting. A variety of computer configurations are consistent with the present invention. The two functions of indexing and query fulfillment (i.e., obtaining a result for a query) may be divided in any of a number of ways among one or more computers.

II. Information Need Query Structures Search Approach, and Results Generation

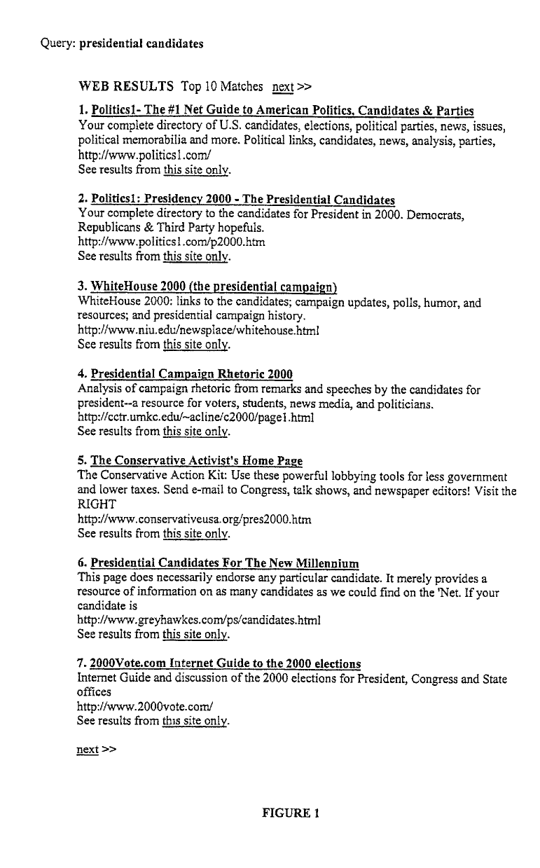

We turn now in further detail to the query structure, searching approach, and results generation aspects of the Information Need invention. As described in the Background, traditional search and query systems accept a query containing one or more specified terms and return a list of documents containing the terms as illustrated in FIG. 1. In this regard it is noted that a term, as used herein, refers to a sequence of characters, including letters and/or numbers. A query, as used herein, is a character string that consists of any number of terms separated by spaces and/or special symbols. In general, a query is issued by a user seeking specific information related to the term(s) in the query. Thus a query is an indication of an information need. It is presumed that documents in which the query terms occur are more likely to contain the desired information than documents that do not contain those terms. Traditional search and query systems expedite the process of obtaining information by identifying documents that contain the query terms. However, the documents themselves, or sections of the documents, must still be examined by a human user in order to obtain the desired information. Furthermore, in order to have confidence in the information, it may be necessary to examine numerous documents.

The Information Need invention provides a new approach to the task of gathering information related to a query. The invention allows the processing of a query containing an unspecified portion in addition to or instead of a specified portion. The unspecified portion of the query corresponds to an information need, for example, an item of information sought by a user. Thus rather than merely including terms that are related to an information need, a query containing an unspecified portion according to the present invention can more explicitly express the need. As described in detail below, the invention then addresses the need by identifying matches for the query that occur within a body of information such as a collection of documents. Instead of returning only document locations and/or identifiers and possibly document summaries as results for the query, the present invention returns the matches themselves or portions of the matches that correspond to the unspecified portions of the query. Document locations and/or identifiers and other information can optionally be returned in addition to the matches.

In certain embodiments of the invention, the matches are ranked according to any of a variety of criteria. A general feature of the ranking criteria is that they are based on the content of a plurality of documents. One such criterion is the number of times an instance of the match is identified across all or a subset of documents in which the match occurs. (The words identifying and locating will be used interchangeably herein in reference to the process of finding a match or finding a context.) Thus ranking criteria of the present invention differ from criteria used in traditional search and query systems. Such systems may rank a given document based on the number of occurrences of the query term(s) within that document. In other words, in traditional systems documents in which the query terms appear with a high frequency receive a higher ranking than documents in which the query terms occur less frequently. In contrast, the present invention ranks matches for queries rather than ranking documents that contain query terms, and the ranking is based on the content of multiple documents. It is noted that the general strategies discussed herein, including identifying a match and/or a plurality of matches, assigning a score to the matches (e.g., a score based on the number of times an instance of the match is identified), and ranking the different matches based on the score are not limited to situations in which the matches are located within a plurality of documents. Instead, the strategies are also applicable to any body of information regardless of whether the information is in the form of discrete documents. Similarly, a query having the query structure of the present invention as described below, i.e., a query containing one or more wholly unspecified and/or one or more partially unspecified terms, may be used to identify matches within any body of information, including a single document as well as within a plurality of documents.

Turning now to the structure and features of a query, the present Information Need invention operates on partially unspecified queries, i.e., queries that contain an unspecified portion. The unspecified portion of a query may be represented by a special symbol such as an underscore within the query and may include one or more unspecified terms. As described below, an unspecified term may be wholly or partially unspecified. By way of example, the query

Windows_{—}

contains an unspecified portion. This query consists of two terms, of which the first is the specified (fully defined) term Windows. The second term (represented by an underscore) is unspecified and can represent any word, number, or other character sequence. Thus the unspecified portion of this query consists of a single unspecified term. A query containing an unspecified portion is matched to a character string when the following conditions are met:

(1) For each of the specified terms in the query, an equivalent (matching) term is located at the corresponding position in the character string.

(2) For each of the wholly unspecified terms in the query, a term (any term) is located at the corresponding position in the string.

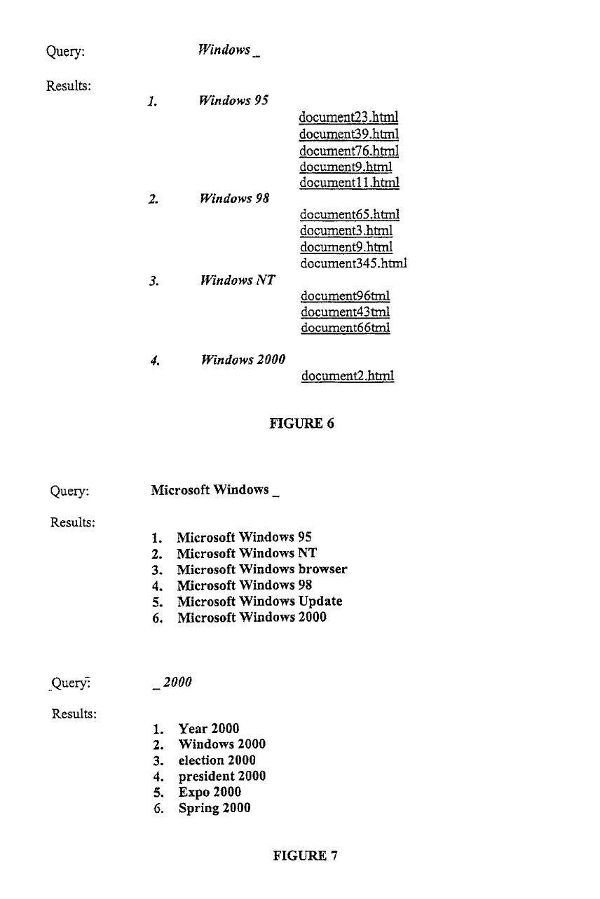

Thus, the phrases Windows 95, Windows 98, Windows NT and Windows 2000 are all matches for the query Windows_. FIG. 6 shows results for the query Windows_according to one embodiment of the Information Need invention. In this embodiment, the matches are ranked based on the number of documents that contain the match and are presented according to this order. Since the match Windows 95 occurs in the most documents (five) it is presented at the top of the list. The match Windows 2000 occurs in only one document and is therefore presented at the end of the list. Information identifying the document(s) in which a particular match occurs is also provided in the results.

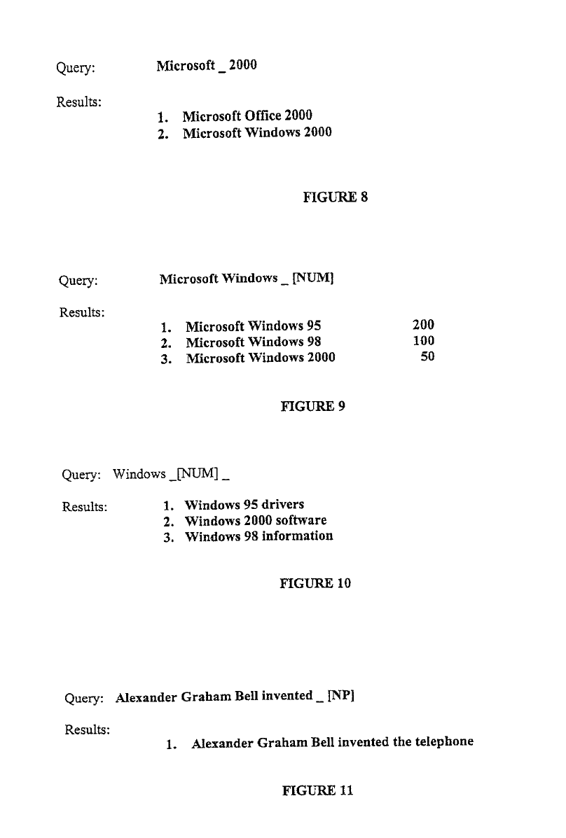

The specified portion of the query can be of arbitrary length, i.e., can contain any number of terms. For example, FIG. 7 shows an example of results for the query Microsoft Windows_in which the specified portion consists of two specified terms. Such a query matches the phrases Microsoft Windows 95, Microsoft Windows NT, and Microsoft Windows browser among others. An unspecified portion can occur at any position within the query. In the preceding example the unspecified portion (a single unspecified term) follows the specified portion. In contrast, FIG. 7 further shows an example of results for the query_{—}2000 in which the unspecified portion (a single unspecified term) precedes the specified portion. Matches for this query include year 2000, Windows 2000, and election 2000 among others. FIG. 8 shows exemplary results for the query Microsoft_{—}2000 in which the specified portion contains two terms that are separated by the unspecified portion (a single unspecified term).

As another example, the query

_Windows_{—}

consists of two unspecified terms separated by the specified term Windows. This query matches the phrases Microsoft Windows 95, Microsoft Windows 98, installing Windows 95, and using Windows 98, among others.

In general, a term in a character string is equivalent to a specified term in a query if it is identical to the specified term. However, in certain embodiments of the invention a term may be considered as equivalent to a specified term even if the term is not identical to the specified term but is instead related to the specified term in some manner. For example, in certain embodiments of the invention morphologically related words such as leave and left may be considered as equivalent.

As described above, an unspecified term can represent any character sequence. Such an unspecified term is referred to herein as a wholly unspecified term. According to the Information Need invention an unspecified portion of a query can contain one or more partially unspecified terms in addition to or instead of one or more wholly unspecified terms. A partially unspecified term includes a restriction that defines a particular set of character sequences that can match the term. For example, a restriction on a partially unspecified term may require that a matching term be a number, a proper name, a noun phrase, etc. By way of example, the queries

Microsoft Windows_[NUM]

and

Agatha Christie was born in_[NUM]

contain a partially unspecified term with a restriction indicating that only a number can satisfy the restriction and therefore match the term. A query containing a partially unspecified portion is matched to a string when the following conditions are met:

(1) For each of the specified terms in the query an equivalent (matching) term is located at the corresponding position in the string.

(2) For each of the wholly unspecified terms in the query a term (any term) is located at the corresponding position in the string.

(3) For each of the partially unspecified terms in the query a term or a group of terms that satisfies the restriction associated with the partially unspecified term is located at the corresponding position in the string.

FIG. 9 shows an example of results for the query Microsoft Windows_[NUM]. As shown in the Figure, the phrases Microsoft Windows 95, Microsoft Windows 98, and Microsoft Windows 2000 are matches for the query. However, the phrase Microsoft Windows NTis not a match since NT does not satisfy the restriction that the partially unspecified term be a number. Similarly, the query Agatha Christie was born in_[NUM] matches the phrase Agatha Christie was born in 1890 but does not match the phrase Agatha Christie was born in England. Note that the results presented in FIG. 9 include a score for each match. Methods for obtaining the score are discussed further below.

The Information Need invention also allows a query to contain one or more wholly unspecified terms in addition to one or more partially specified terms. For example, the query

Windows_[NUM]_{—}

contains a partially unspecified term (with an associated restriction that requires that a matching term be a number) in addition to a wholly unspecified tern. FIG. 10 shows an example of results for this query. As shown in the Figure, the query matches the phrases Windows 95 drivers, Windows 2000 software, and Windows 98 information among others.

The set of terms represented by a partially unspecified term can be defined by characteristics a member must possess to satisfy the associated restriction. Examples of restrictions include categories such as proper name, location, country, date, unit of measurement, company name, baseball players, etc. Thus certain restrictions are best defined by lists of terms that fall into certain categories. Certain restrictions may be expressed as a morphological criterion, as a syntactic criterion, or as a computer program. In each case, the restriction defines a requirement that must be met by a term in order to satisfy the restriction. In general, a morphological criterion defines a feature of word structure, function, or inflection. For example, a morphological restriction is used to indicate that a matching term must contain a particular unit (morpheme) such as the unit slow in the words slowly, slowest, etc. A morphological restriction may indicate a category such as a part of speech (e.g., noun, verb, preposition, adjective). Words falling within the category satisfy the restriction. For example, the three phrases Microsoft wins, Microsoft loses, and Microsoft settles are examples of matches for the partially unspecified query Microsoft_[VERB] since wins, loses, and settles each fall within the part of speech category VERB and therefore satisfy the restriction that the partially unspecified term be a verb. A morphological restriction is also used to indicate inflection, i.e., the variation in form of a single word for grammatical purposes, as with take, takes, taken, took, etc. For example, the morphological restriction [PAST TENSE] indicates that a matching term must be the past tense form of a verb.

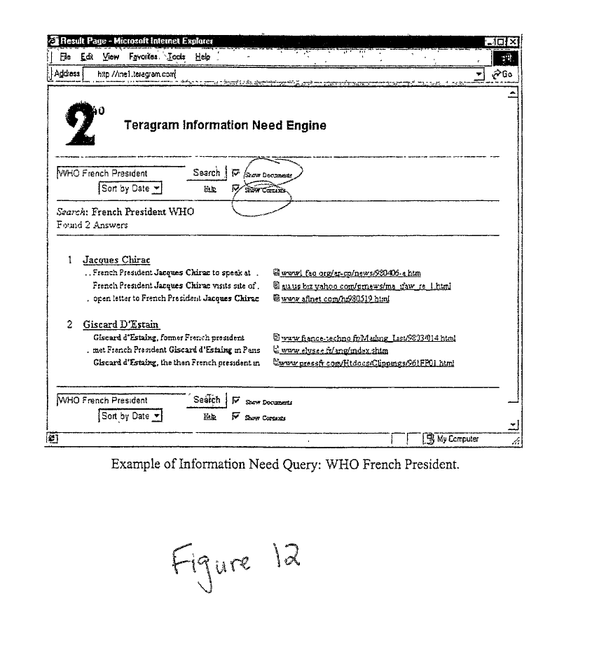

In general, a syntactic criterion defines a feature of sentence structure such as a grammatical unit from which sentences are constructed. Examples of restrictions expressed as syntactic criteria include phrasal categories such as noun phrase, verb phrase, or prepositional phrase. FIG. 11 shows an example of results for the query

Alexander Graham Bell invented_[NP]

in which [NP] is a restriction requiring that only a noun phrase can match the partially unspecified portion of the query. Thus the three strings the telephone, telephones, and many useful devices are noun phrases that match the partially unspecified term_[NP]. Note that the Information Need invention allows either a single term that occurs within a document or a group of terms that occurs within a document to match a partially unspecified term depending upon the nature of the restriction. For example, in general single terms such as through, under, etc., match a partially unspecified term with the restriction [PREPOSITION]. However, groups of terms such as through the looking glass, under the full moon, etc. match a partially unspecified term with the restriction [PREPOSITIONAL PHRASE].

In addition to categories, morphological criteria, and syntactic criteria, a restriction can also be expressed as a computer program that is invoked to determine whether a particular term or group of terms satisfies the restriction. Further details regarding this form of restriction are provided below.

It is noted that a partially unspecified query of the Information Need and present inventions are distinct from a query in which a term contains a wildcard character. In general, a wildcard character is a character whose purpose is to allow variations in length or spelling of a single term. In certain prior art search and query systems such wildcard characters may occur as part of a term that is otherwise fully specified. For example, the asterisk in the term col*r permits the recognition of either color or colour. Similarly, the asterisk in comput* permits recognition of computer, computers, computation, etc. Thus a wildcard character permits variation within the term that contains the wildcard character, but the variation is constrained by the defined letters in the term. A query in which a term includes a wildcard character is, in fact, fully specified with the exception that certain variations in length or spelling are permitted within an individual term including the wildcard. In contrast, in accordance with the Information Need and present inventions an entire term or terms can be unspecified. Thus with regard to these inventions a wholly unspecified term in a query matches any term, without requiring the presence of specific letters. In accordance with the Information Need and present invention a match for a partially unspecified term is constrained by the restriction associated with the partially unspecified term rather than by a requirement for the presence of specific letters. Of course the inventions also encompasses the use of wildcard characters within terms that are otherwise fully specified.

One application of the Information Need and present inventions lies in the task of answering a natural language question. In this application, in addition to accepting a query such as those described above, query preprocessor 32 accepts a natural language question and converts the question into a partially unspecified query. A match for the query constitutes an answer for the question.

III. Indexing Module of Information Need

Turning now to the operation of the Information Need invention, as shown in FIG. 5, applications stored on indexing computer 6 include indexer module 44. In certain embodiments of the inventions, prior to the processing of any queries an indexing phase is performed in which terms that occur within documents are stored in a data structure known as an index 50. For a given term, the index 50 identifies documents that contain the term. In preferred embodiments of the invention, text strings containing the term known as contexts are also stored. In certain embodiments of the inventions the number of instances of a term within a document is also stored.

In general, any collection of documents to which the inventions have access can be used as a source of documents. In certain embodiments of the invention the documents are stored in document storage area 47. It is noted that the invention does not necessarily store the actual full text of the documents but may instead store a representation of the documents, e.g., using numbers to represent text. Although for purposes of description it will be assumed that in those embodiments of the inventions in which matches are located within documents, the inventions store the full text, it is to be understood that this need not be the case. Furthermore, in descriptions of searching and matching provided below, the actual operations may be carried out on numerical representations of character strings rather than on the character strings themselves. In addition to storing the documents themselves, information about the documents such as the URL (for Web pages), date of creation, etc., is preferably also stored. In certain embodiments of the inventions document storage area 47 resides in memory 43, although this need not be the case. Portions of document storage area 47 may be located on different storage media and devices. In certain preferred embodiments of the inventions the documents are World Wide Web pages. Web documents may be identified by Web robot 46.

As used herein the word “indexing” is used broadly to refer to any of a number of processes by which information associating a term T with a body of information containing the term is stored on a computer-readable medium. For example, indexing may identify documents in which term T occurs. As described below, indexing may identify character strings or contexts in which a term T occurs. Since for purposes of the present invention a body of information containing a term is typically a body of text, these two phrases will be used interchangeably. An index comprises the terms and actual information identifying, for a term T, the bodies of text that contain T. In certain embodiments of the invention, an index also comprises a body of text that contains T.

According to one embodiment of the invention, indexer module 44 uses traditional techniques of indexing such as the one described by Salton (mentioned above) to create an index of terms, e.g., words that appear within documents. For each indexed term, the index contains an identifier for documents in which the term appears. In certain embodiments of the invention the index also includes data identifying the location(s) of a given term within the document(s) in which the term occurs. In certain situations, depending upon factors such as the size and number of the documents, the inclusion of such information greatly speeds the process of searching for matches. It is noted that the indexed terms preferably include single words and numbers and also certain groups of words or phrases. For example, proper names such as Agatha Christie and Rocky Mountains may be indexed as well as compound terms such as cocker spaniel or air base.

In preferred embodiments of the invention index 50 is stored in memory 42 of indexing computer 6 and is copied to memory 15 of query server 4 at appropriate intervals (e.g., after updating). However, the invention is not limited to storing the index there. The index can be stored in peripheral storage comprising additional hard disks or, in general, on any computer-readable medium. Furthermore, portions of the index may reside on different devices and/or media, and part or all of the index can be copied or transferred from one device to another as appropriate. Construction and manipulation of indices containing thousands of terms and referencing thousands of documents is well known to those of ordinary skill in the art.

In addition to indexing terms as described above, indexer module 44 also indexes restrictions that may be associated with partially unspecified terms in a query. In other words, for each restriction, indexer module 44 identifies documents that contain a string that satisfies the restriction. Indexing of restrictions may occur concurrently with indexing of specified terms or in a separate phase. In the former case, as indexer module 44 identifies a term to be indexed, it also determines which, if any, restrictions the term satisfies. For example, if indexer module 44 encounters the term Microsoft within a document D1, it recognizes that Microsoft satisfies the restrictions [NOUN], [NAME], and [COMPANY NAME] among others. Then, in addition to storing the information that Microsoft occurs in document D1, indexer module 44 stores the information that a string that meets the [NOUN] restriction occurs within document D1. Indexer module 44 also stores the information that a string that meets the [NAME] and [COMPANY NAME] restrictions occurs within document D1. To provide a further example, if indexer module 44 encounters the term 1890 within a document D2, it recognizes that 1890 satisfies the restrictions [NUM] and [DATE] among others. Then, in addition to storing the information that 1890 occurs in document D2, indexer module 44 stores the information that a string that satisfies the [NUM] and [DATE] restrictions occurs in document D2. Alternatively, the indexing of restrictions may take place in a separate phase to the indexing of terms. In such a case rather than first selecting a term or group of terms within a document and then determining which restrictions it satisfies, indexer module 44 first selects a restriction and then extracts from a document those terms or groups of terms that satisfy the restriction. Indexer module 44 repeats this process for each restriction. Of course indexer module may use a combination of these or other approaches or select a particular approach depending upon the situation.

The restrictions that are indexed may include any or all of those described in the section on query structure and features, including those that are satisfied by groups of terms in addition to those that are satisfied by a single term. For example, indexer module 44 identifies documents that contain terms or groups of terms that satisfy the restrictions [NP] (noun phrase), [VP] (verb phrase), [PAST TENSE], etc. In summary, indexer module 44 indexes both terms that occur within documents and also restrictions satisfied by strings within documents. In the case of a term, the index identifies documents containing the term. In the case of a restriction, the index identifies documents containing a term or group of terms that satisfies the restriction. The indexing of restrictions greatly facilitates the processing of queries that contain partially unspecified terms associated with such restrictions.

Depending on the nature of the restriction, indexer module 44 uses a variety of techniques to determine whether a string satisfies a restriction and/or to extract strings that satisfy restrictions from documents. For example, in the case of restrictions such as [COMPANY NAME], [COUNTRY], etc., it is possible to enumerate a list of terms that satisfy the restriction. In such a case indexer module 44 may simply compare a term T that occurs within a document with predefined category lists 48 that include terms that satisfy the restriction to determine whether term T satisfies the restriction. Depending upon the restriction, category lists 48 may be prepared by a human being. (Note that such lists need not necessarily be stored at the search site but may be accessed, for example, over a network.) To determine whether a term satisfies certain morphological or syntactic restrictions such as [NOUN], [VERB], [PREPOSITION], etc., indexer module 44 may refer to a stored dictionary or dictionaries 49 containing information regarding word form, part of speech, compound words and phrases, etc. Preferably category lists 48 and dictionaries 49 as are needed by indexer module 44 are stored in memory 43, at least during the indexing phase. In order to identify terms or groups of terms that satisfy more complex morphological or syntactic restrictions such as [NP], [VP], etc., indexer module 44 may use any of a variety of known techniques of text analysis. Techniques for parsing, performing morphological and syntactic analysis, etc. are described, for example, in Collins, M., Three Generative, Lexicalised Models for Statistical Parsing, Proceedings of the 35^{th} Annual Meeting of the ACL (jointly with the 8^{th} Conference of the EACL, Madrid, 1997; Collins, M., A New Statistical Parser Based on Bigram Lexical Dependencies. Proceedings of the 34^{th} Annual Meeting of the Association for Computational Linguistics (ACL), pages 184-191, 1996; Magerman, D., Statistical Decision-Tree Models for Parsing. Proceedings of the 33^{rd} Annual Meeting of the ACL, pp. 276-283, 1995; Woods, W. A., Transition Network Grammars for Natural Language Analysis, Communications of the ACM, Vol. 13, No. 10, October, 1970; Roche, E., Looking for Syntactic Patterns in Texts in Papers in Computational Lexicography. Complex '92, Kiefer, F., Kiss, G., and Pajzs, J. (eds.) Linguistic Institute, Hungarian Academy of Sciences, Budapest, pp. 279-287; Karp, Schabes, Zaidel, and Egedi, A Freely Available Wide Coverage Morphological Analyzer for English, Proceedings of the 15^{th} International Conference on Computational Linguistics, Nantes, pp. 950-954, 1992. The contents of the preceding references are hereby incorporated by reference in their entirety. In certain instances indexer module 44 invokes a computer program to determine whether a given term satisfies the restriction. The computer program accepts the term as input and provides as output an indication of whether the term satisfies the restriction. One example is the restriction [PRIMENUM], which is satisfied by the infinite set of prime numbers. Such a set cannot be enumerated, and the most straightforward way to recognize terms that satisfy the restriction is through the use of a program that is able to determine whether a number is a prime. The following final query example illustrates the use of this restriction. The query

_[NAME] was born in_[PRIMENUM]

identifies individuals who were born in a year that is a prime number. Results for this query include, among others, Charlie Chaplin was born in 1889 since Charlie Chaplin satisfies the restriction [NAME] and 1889 is a prime number. Such a query would not match Agatha Christie was born in 1890 because, although Agatha Christie is a name, 1890 is not a prime number.

During the indexing process, in addition to storing information that identifies documents containing terms that satisfy restrictions, in preferred embodiments of the invention indexer module 44 stores the location of the terms within the documents. For example, if the term ‘Microsoft’ appears in three locations L1, L2, and L3 within document D1, then indexer module 44 stores the fact that a term satisfying the [NOUN] restriction appears within document D1 at locations L1, L2, and L3. Indexer module 44 also stores the fact that a term satisfying the [NAME] and [COMPANY NAME] restrictions appears in D1 at L1, L2, and L3). When a restriction is satisfied by a string containing more than a single term, indexer module 44 stores both the beginning and ending locations of the string. In certain embodiments of the invention the number of instances of a term within a document is also stored.

As indexer module 44 identifies and indexes terms that appear within documents, it may also store various types of information about the terms. Such information may include the position of the term within a document, features of the format of the term within the document, etc. For example, if a term appears within a title or within a bulleted list in document D1, indexer module 44 may include such information when storing the fact that the term occurs within D1. Format features include such characteristics as font size, boldface, italics, color, etc. For example, if the term ‘Microsoft’ occurs within the title in boldface in document D1, embedded within the text of document D4, and in italics within document D7, an entry for the term Microsoft may appear (in schematic form) as follows:

| | | |
|---|---|---|
| Microsoft | D1 | bold, title |
| | D4 | |
| | D7 | italics |

As described above, indexer module 44 indexes restrictions as well as terms, i.e., indexer module identifies documents that contain terms that satisfy the indexed restrictions. As for term entries, a restriction entry may also include information regarding the position and format of term(s) that satisfy the restriction. Thus in the example of the term Microsoft described above, the entries for the restriction [COMPANY NAME] may appear (in schematic form) as follows:

| | | | |
|---|---|---|---|
| Company Name | D1 | Microsoft | bold, title |
| | D4 | Microsoft | |
| | D7 | Microsoft | italics |

Of course similar entries also appear for the other restrictions, e.g., [NOUN], [NAME] satisfied by the term Microsoft. As mentioned previously, the restriction entries also include the locations within documents of term(s) that satisfy the restriction.

It is noted that in the preferred embodiment of the invention in which the documents are Web pages, location and format features of terms within documents are typically encoded in the form of HTML tags within the documents themselves. This fact simplifies extraction of location and format features for terms.

IV. Extended Matching Technique Overview

As described above and in the Information Need application, a character string that constitutes a match for a partially unspecified query must meet the following criteria:

(1) For each of the specified terms in the query an equivalent (matching) term is located at the corresponding position in the string.

(2) For each of the wholly unspecified terms in the query a term (any term) is located at the corresponding position in the string.

(3) For each of the partially unspecified terms in the query a term or a group of terms that satisfies the restriction associated with the partially unspecified term is located at the corresponding position in the string.

It will be appreciated that according to the above criteria, the order of terms in a match must exactly correspond with the order of terms in the partially unspecified query. Of course since a partially unspecified term in a query can be matched by a group of terms, the number of terms in the query and in the match need not be equal, but the relative order of the terms in the query and the corresponding terms or groups of terms in the match must be preserved. Thus, for example, according to the criteria presented above, the partially unspecified query

Agatha Christie was born_[LOCATION]

would be matched by the string Agatha Christie was born in England (since in England satisfies the restriction [LOCATION]) but would not be matched by the string Agatha Christie was born and raised in England since there are no terms in the query that correspond to the terms and and raised in the latter string.

Note that the word match can be used to refer either to the entire string that matches the query as described above or to simply that portion of the entire matching string that corresponds to a particular partially unspecified term in a partially unspecified query. For example, the string Agatha Christie was born in England is a match for the query above. However the string in England is also referred to as a match since it corresponds to the partially unspecified term_[LOCATION], i.e., it fulfills the [LOCATION] restriction. In general, when discussing the extended matching technique, the word “match” will be assumed to refer to just the portion of a matching string that corresponds to a partially unspecified term rather than to a matching string that also includes fully specified terms from the query.

The extended matching technique modifies the criteria for a match. According to the extended matching technique, in an extended match the relative order of (1) the term or group of terms in the extended match that correspond(s) to a partially unspecified term in the query and (2) the terms or term synonyms in the extended match that correspond to the fully specified terms in the query need not be preserved. For example, consider the query above in which the partially unspecified term indicated by the restriction [LOCATION] follows the fully specified terms in the query. As discussed above, the methods presented in the Information Need application would only identify a valid match in a passage of text in which a term or group of terms that satisfies the restriction (e.g., in England) follow terms that match the fully specified terms. Thus a valid match would be identified in a passage such as the following:

Agatha Christie was born in England and spent much of her life there.

However, these methods would not identify a valid match in a passage such as the following:

England is where Agatha Christie was born and lived for much of her life.

Due to the fact that the methods in the Information Need application require that a match will only be identified in a string that preserves the order of the query, the methods fail to identify the phrase England is where Agatha Christie was born as a match for the query and thus fail to identify the term England as a match for the partially unspecified term_[LOCATION]. The extended matching technique addresses this limitation. In certain preferred embodiments of the invention referred to as “Unordered Query” the extended matching technique allows for a match in cases in which the query terms (both fully specified and partially unspecified terms) all appear within a single document (or, as discussed below, in certain embodiments of the invention within a single context) but where they appear in any order relative to one another. In other words, there are no requirements that the terms in the document that match the terms in the query have any particular order. In addition, the document or context may contain intervening words separating the terms that match the fully specified terms in the query. There may also be intervening words separating the terms that match the partially unspecified term(s) and those that match the fully specified term(s). In certain preferred embodiments of the invention referred to as “Ordered Query” the extended matching technique allows the user to specify that some or all of the terms in the query must appear in a particular order in order for a match to occur.

The following examples illustrate the operation of the Unordered Query embodiments of the extended matching technique. Consider first the simple unordered query

Smithsonian_[LOCATION]

The extended matching technique will identify locations that appear either before or after the fully specified term Smithsonian whether or not there are intervening words between a string that fulfills the [LOCATION] restriction and the term Smithsonian. Thus the extended matching technique will return as a match the location Washington, D.C. from any of the following three passages of text (among others):

The Smithsonian is one of the most popular tourist attractions in Washington, D.C.

Visit the Smithsonian, Washington, D.C., if you ever get the chance!

Washington, D.C. is home to the Smithsonian and many other excellent museums.

Note that only the second passage would include a match according to the techniques described in the Information Need application.

As another example, consider the more complex unordered query (in which the restriction [NHUM] stands for NOUN HUMAN and indicates that human names will match)

French president_[NHUM]

The extended matching technique will identify the name in each of the following passages as a match.

French president Jacques Chirac will address the United Nations on Wednesday.

Jacques Chirac was reelected as French president.

The French honored former President Giscard d'Estaing in a nationally televised ceremony.

President Charles de Gaulle is one of the heroes of the French people.

Note that the extended matching technique allows the match (e.g., Jacques Chirac) to occur either before or after the terms French president. Note also that there may be (but need not be) intervening words between French president and the matching name. In addition, there may be (but need not be) intervening words between the fully specified terms French and president, and the fully specified terms can occur in any order relative to each other and relative to the matching term(s).

In certain preferred embodiments of the invention referred to as “Ordered Query” the extended matching technique allows a requirement that some or all of the terms in the query appear in the given order, without any intervening terms, within the document or context. (Of course a match for a partially unspecified term may be a group of terms rather than a single term.) The terms whose order must be maintained will be indicated herein by placing them within quotation marks, though of course a variety of other forms of annotation may be used. Consider, for example, the following ordered query:

“French president”_[NHUM]

This ordered query will identify matches only within the first two passages above since only those passages contain the fully specified terms French and president in the required order and adjacent to each another. An ordered query such as that above in which the order of only some of the terms must be maintained within a document or context in order for a match to be identified is referred to as a partially ordered query.

The order requirement may also encompass one or more partially unspecified terms and/or a mixture of fully specified terms and partially unspecified terms. For example, the ordered query

“French president_[NHUM]”

will only identify matches where the terms French and president appear in the specified order with a human name adjacent to president. Thus only the first passage above contains a match for this query. Note that functionally an ordered query in which all terms appear within quotation marks should return the same results as a similar query using the technology described in the Information Need application. This type of query is referred to as a fully ordered query.

It will be appreciated that the various query forms (ordered query in which all terms are ordered, ordered query in which some but not all terms are ordered, unordered query) represent a tradeoff in terms of specificity and breadth. Thus an ordered query in which all terms are ordered may be most likely to return an accurate result (e.g., a match that correctly fulfill the information need) but at the expense of missing some matches that may correctly fulfill the need. On the other hand, the unordered query may offer the greatest likelihood of finding any potentially correct information.

Note that although in certain embodiments of the invention the user is permitted to specify whether the query should be ordered or unordered, in other preferred embodiments the system may automatically generate one or more queries including ordered and/or unordered queries from an input query. As described in the Information Need application, in certain preferred embodiments of the invention the query results are ranked. The ranking may take into account, in addition to the criteria discussed in that application, other criteria such as whether the match was identified using an ordered or unordered query. In the case of a match that was identified using a query that does not fully specify the order for all terms, the ranking may consider, for example, the degree of order imposed by the query, the number of intervening terms between the matching terms in the document or context, the number of instances of the match within all documents or contexts, etc. Additional ranking criteria are described in the Information Need application. Since the extended matching technique, while expanding the set of possible matches for a partially unspecified query, may increase the likelihood of returning an inappropriate result for the query, in certain preferred embodiments of the invention the extended matching technique using unordered or partially ordered queries is only employed if use of the more rigid fully ordered query fails to identify a sufficiently large set of matches.

V. Extended Matching Query Formulation and User Interface Considerations

A system according to the present invention may allow any of a variety of approaches for expressing a particular query. For example, different selections can be made for the words or abbreviations that are used to indicate restrictions. As will be evident to one of ordinary skill in the art, the particular choice of words or abbreviations that designate a particular restriction is not significant provided that consistency is maintained between the indexing of terms that satisfy the restriction and the restriction as ultimately used in performing the matching process. Thus it may be easier for a user to employ a question word (e.g., WHO, WHAT, WHEN, WHERE) rather than a corresponding restriction (e.g., NHUM, NOUN PHRASE, DATE, LOCATION). When using question words, for example, the query_[LOCATION] born Benjamin Franklin could be expressed as_[WHERE] born Benjamin Franklin. The invention may accept input queries containing question words and convert them into queries containing the appropriate restriction. (Note that the preceding lists are nonexhaustive and are intended to be representative only.)

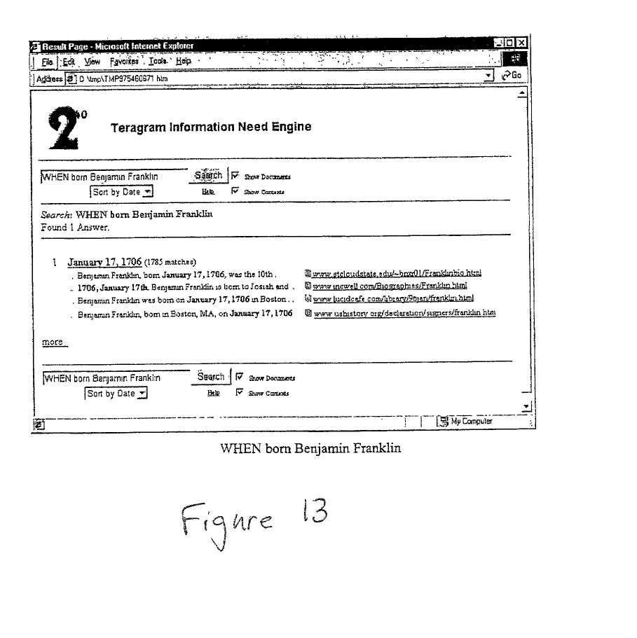

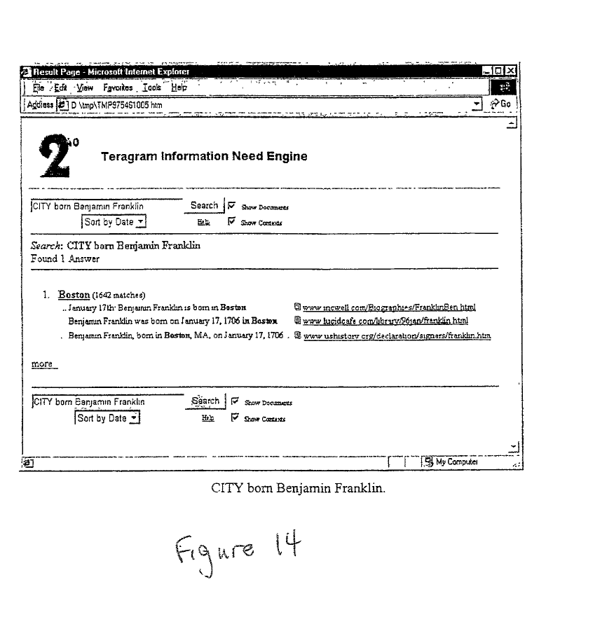

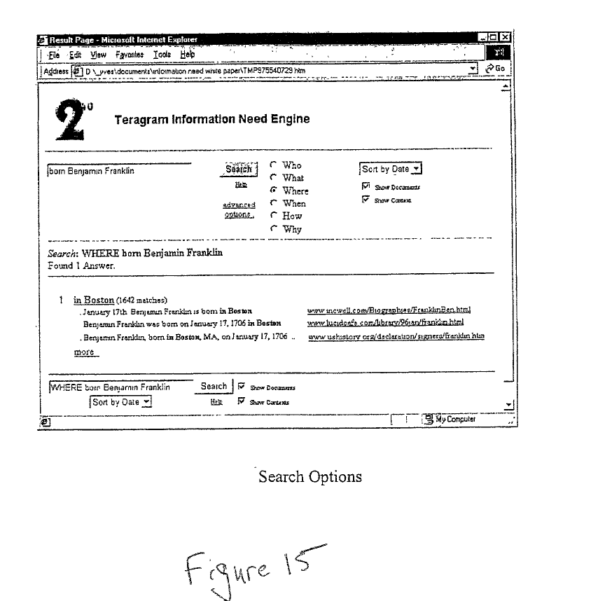

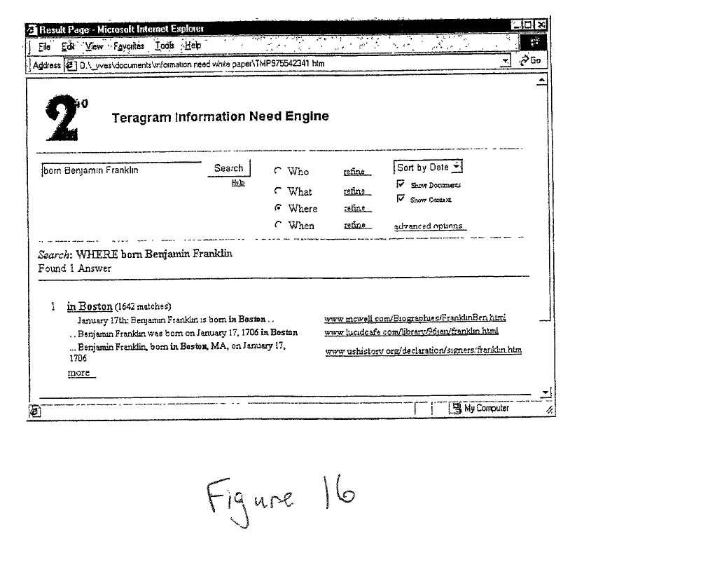

A variety of user interfaces may be employed as shown in FIGS. 12 through 16 and 21A, 21B, which illustrate the invention in the context of searching for information on the World Wide Web. FIG. 12 shows a screen dump illustrating results for the query_[WHO] French President (which could also have been expressed as_[NHUM] French President according to the query structure of the Information Need application). FIG. 13 shows a screen dump illustrating results for the query_[WHEN] born Benjamin Franklin (which could have been expressed as_[DATE] born Benjamin Franklin). FIG. 14 shows a screen dump illustrating results for the query_[CITY] born Benjamin Franklin. FIG. 15 shows an alternative user interface that allows a user to select the question word Where to express an information need. The query generated by this selection is presented following the word Search in the figure. FIG. 16 shows an alternative user interface that allows a user to select the question word Where to express an information need. The query generated by this selection is presented following the word Search in the figure.

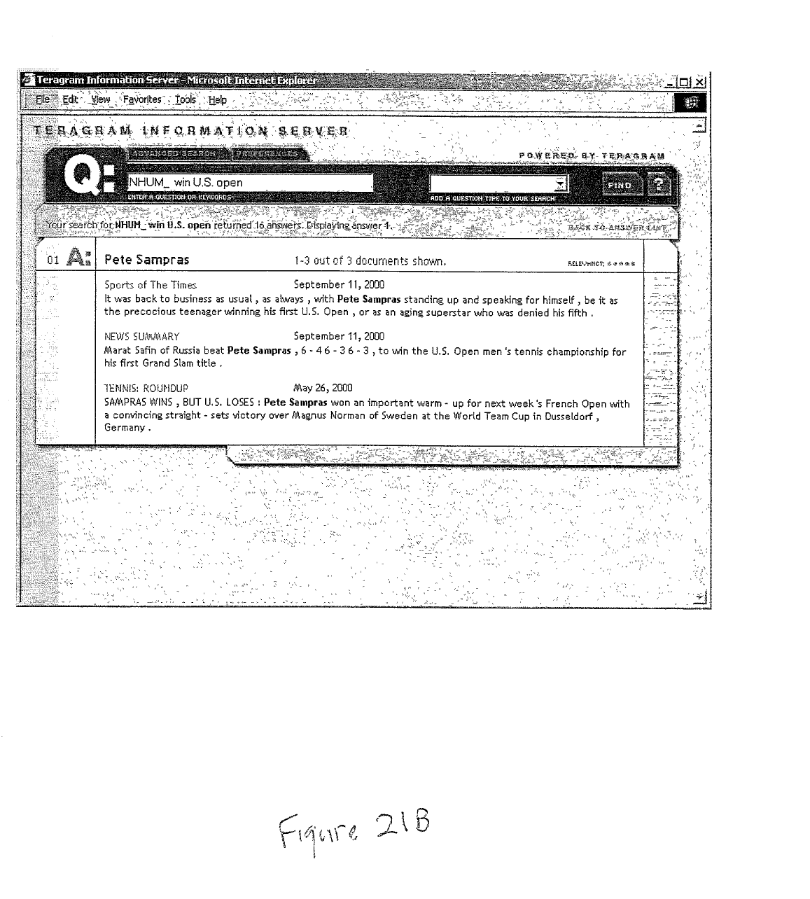

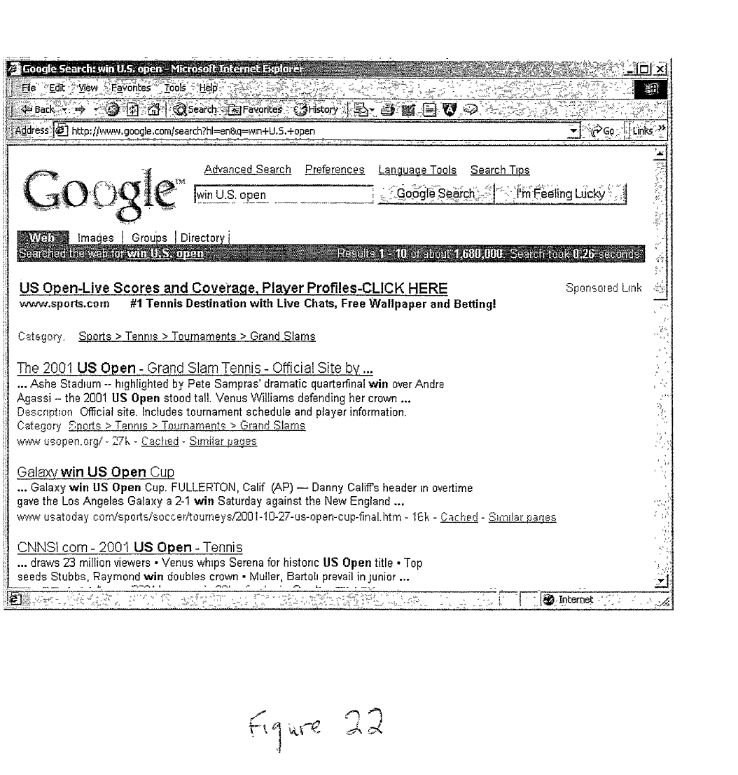

Note that FIG. 16 presents the user with the option to refine the search, e.g., by applying narrower restrictions such as [CITY], [COUNTRY], etc. A wide range of more detailed categories of restrictions may also be available to the user in some embodiments. Note also that in addition to returning a match itself, e.g., a string such as in Boston, the results optionally include a passage of text containing the match and/or a document identifier (in this case a link to the document). In yet another user interface, as shown in FIG. 21A, a drop-down window allows a user to select among a large number of category restrictions that assist in building a query. Note that matches (Pete Sampras, Marat Safin, Pam Sshriver) are returned as answers to the query_[NHUM] win U.S. open with an indication of how relevant the system believes the answer to be. Also note that contexts for each match appear in this interface without a document identifier, but with a hyperlink to the complete document containing the context. An option presented to a user in this interface is to select to display more documents, if any exist, associated with a particular match. FIG. 21B illustrates the results when a user chooses to view additional documents associated with match Pete Sampras. For comparison purposes, FIG. 22 illustrates the results for running the query win U.S. open on the GOOGLE™ search engine system.

VI. Extended Matching Technique Implementation and Data Structures

As discussed in the Information Need application, in the implementation phase of the system an indexing module indexes documents that will serve as an information source. In addition to indexing individual terms and groups of terms (e.g., phrases), the indexing module undertakes a linguistic analysis of the documents. In the course of this analysis, terms that satisfy any of a variety of restrictions (e.g., PERSONAL NAME, COMPANY NAME, LOCATION, ADDRESS, CITY, DATE, etc.) are identified and indexed. Thus the indexing module identifies terms in text that fall into various categories. The indexing module also identifies and indexes terms that satisfy morphological or syntactic criteria or that satisfy a computer program. For example, the indexing module identifies and indexes terms that meet criteria such as NOUN PHRASE, VERB, PREPOSITIONAL PHRASE, etc.

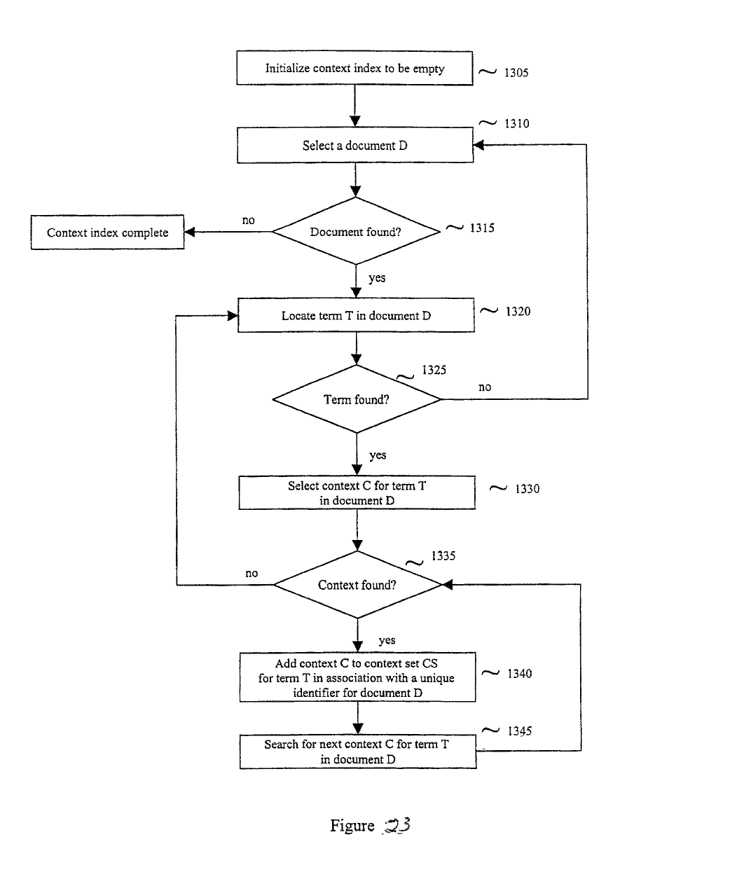

FIG. 23 illustrates the preparation of an index that stores contexts. In step 1305, the context index is initialized to be empty. In step 1310, context indexer module 46 selects a new document (i.e., a document that has not yet been processed) from a database. At decision step 1315, if a new document D has been found context indexer 38 proceeds to step 1320, in which a new term T in document D (i.e., a term for which a context set from document D has not yet been obtained) is selected. At decision point 1325, if a new term T has been found context indexer module 45 proceeds to step 1330. In step 1330 context indexer module 45 searches for a context C for term T. If a context for T is found, context indexer module 45 proceeds through decision step 1335 to step 1340, in which context C is added to the set of contexts CS for term T in association with a unique identifier for document D. At this step information about the context such as its position within a document may also be stored. Step 1340 is discussed in more detail below. In step 1345, context indexer module 45 searches for the next context C for term T within document D. Steps 1335 through 1345 are repeated sequentially until no more contexts for T within D can be found. Processing then returns to step 1320, in which a next term T is selected. Steps 1325 through 1345 are repeated until a new term can no longer be found within document D. Processing then returns from decision step 1325 to step 1310, in which a new document is selected. Steps 1310 through 1345 are repeated until no new documents can be found, at which point the context index is complete and processing stops.

Although as described above a context set is generated for every term within document D, in certain embodiments of the invention context indexer module 45 does not obtain a context set for certain terms, e.g., common words or words that have a low information content such as a, the, it, etc. Such words can be screened out at steps 1320.

Note that in addition to storing contexts for specified terms, context indexer module 45 may store contexts that satisfy restrictions. For example, a string such as Alexander Bell invented the telephone in 1876 can serve as a context for the specified term telephone. Since the telephone is a noun phrase, Alexander Bell invented the telephone in 1876 is also a context that satisfies the restriction [NP]. Of course, the string is also a context for the restrictions [PROPER NAME], [VERB], [DETERMINER], among others, since it contains terms or groups of terms that satisfy these restrictions. It is noted that in certain embodiments of the invention the context set CS for a term T actually consists of multiple subsets of contexts, each subset consisting of contexts found within a single document. These subsets are distinguishable by virtue of the unique document identifier associated with each subset. Such a context set will be referred to as a type I context set. In other embodiments of the invention, however, the contexts are stored without a document identifier. In such a case a single context set exists for each term. Such a context set will be referred to as a type II context set. The data structures in which the context sets are stored are described in further detail below.

Turning in more detail now to step 1340, it is noted that although the contexts can be stored as simple character strings, in preferred embodiments of the invention they are stored as FSAs. In this regard, the concept of using finite state automata to represent natural language is well known in the art and is discussed, for example, in Roche, Emmanuel and Schabes, Yves (eds.), Finite State Language Processing, Ch. 1 (pp. 1-66) and 11 (pp. 329-354), MIT Press, Cambridge, Mass., 1997, the contents of which are herein incorporated by reference. Briefly, a finite state automaton (FSA) is a structure having a finite number of states including an initial state and at least one final state (also referred to as an accept state). The states are connected by a plurality of arcs. The arcs have an input, which defines a requirement that must be met in order to traverse the arc, i.e., to proceed from one state to another. The automaton is driven from state to state by a sequence of inputs. If the automaton is in a final state (accept state) after processing the elements in the input string, then the FSA has accepted the input.

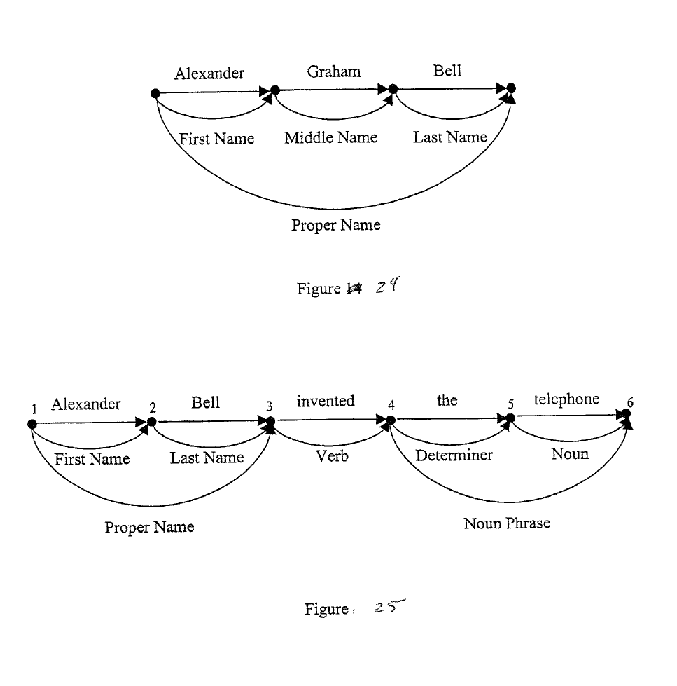

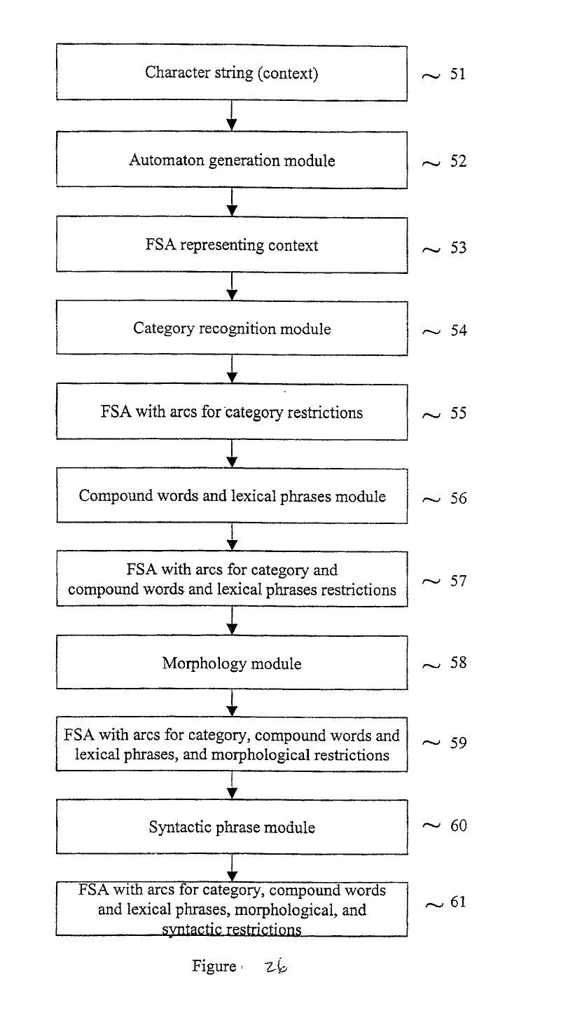

FIG. 24 shows an example of an FSA that represents a context for the string Alexander Graham Bell. Referring to that Figure, it is noted that the FSA includes the terms Alexander, Graham, and Bell. In addition, the FSA includes information about the restrictions that are satisfied by these terms. For example, the FSA contains the information that Alexander Graham Bell is a proper name. The FSA further contains the information that in this case Alexander is a first name, Graham is a middle name, and Bell is a last name. Assuming that the leftmost state is an initial state and the rightmost state is a final state, this FSA accepts the input string Alexander Graham Bell. Depending upon which states are considered as initial and final states, the FSA may accept other inputs. Similarly, FIG. 25 shows an FSA that represents a context for the term telephone. The labels on the arcs of the FSA represent information about the restrictions that are satisfied by various portions of this context. For example, by examining the FSA it can be determined that invented satisfies the restriction [VERB] and that the string the telephone satisfies the restriction [NP] (noun phrase). In this manner, any of the restrictions used in partially unspecified queries, including morphological and syntactic restrictions as well as computer programs, can be expressed in the form of arcs within an FSA. Storing the contexts as FSAs facilitates the rapid and efficient processing of queries containing partially unspecified terms. In particular, the matching process is streamlined since the FSA contains all information needed to determine whether terms in the context satisfy restrictions associated with partially unspecified terms in the query.

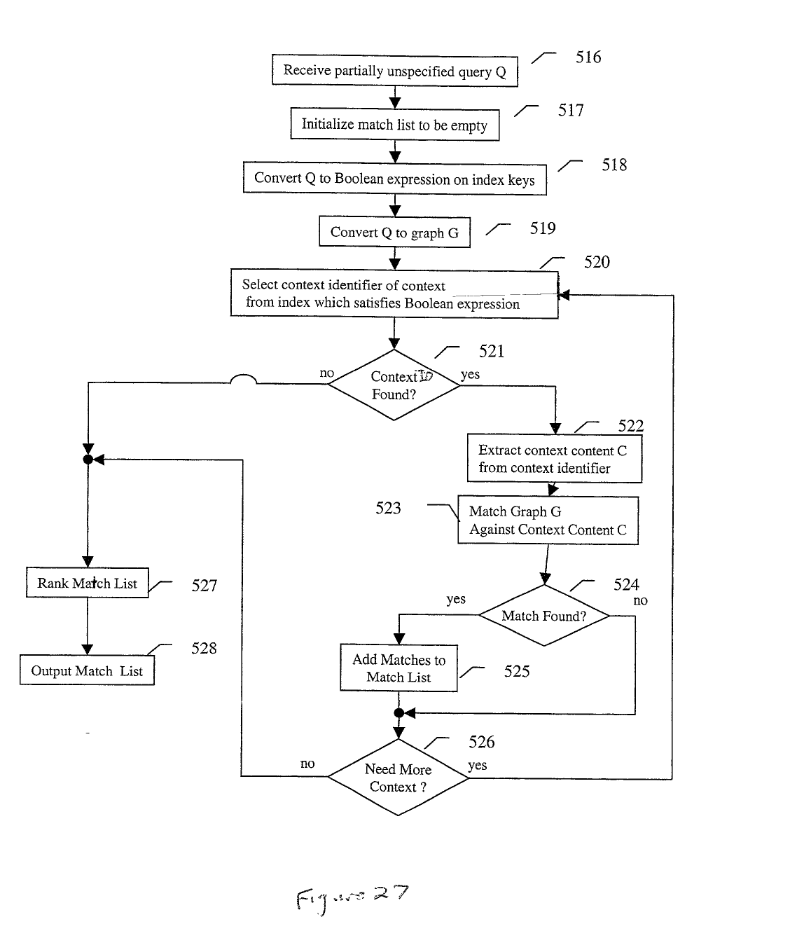

FIG. 26 shows the execution of step 1340 in a case that the contexts are stored as FSAs. Context indexer module 45 passes a character string 51 consisting of an identified context to automaton generation module 52, which is comprised of computer-executable process steps to generate an FSA from an input character string. The context is provided to automaton generation module 52, which produces an FSA 53 that represents the character string. In this regard it is noted that converting the character string into an FSA involves first parsing the string to identify individual terms. The FSA generated by automaton generator 52 includes a plurality of states connected by arcs, with one arc corresponding to each term in the input text. The states and arcs are arranged such that the arc that connects the first two states corresponds to the first term in the character string, and arcs connecting successive states correspond to successive terms in the character string.

Once automaton generation module 52 has constructed an FSA for a context, information indicating which portions of the context satisfy the various restrictions (categories, morphological, syntactic, etc.) discussed above is incorporated. This task is performed by category recognition module 54, compound words and lexical phrases module 56, morphology module 58, and syntactic phrase module 60. After automaton generation module 52 has created FSA 53 for the terms in a context, FSA 53 is provided to category recognition module 54. Category recognition module 54 identifies terms that satisfy various restrictions that are defined as categories (e.g., COUNTRY, CITY, COMPANY NAME) and adds a new arc labeled with the restriction for each term or group of terms that satisfies the restriction. Category recognition module 54 uses stored category lists 28 described above for this purpose. FSA 55, generated by category recognition module 54, is provided to compound words and lexical phrases module 56, which identifies compound words such as air base and lexical phrases such as according to, once in a blue moon, etc. Such compound words or phrases, although comprised of multiple terms, typically behave as a single part of speech and therefore satisfy restrictions such as [NOUN], [PREPOSITION], etc. Compound words and lexical phrases module 56 adds a new arc labeled with the appropriate restriction for each group of terms that satisfies the restriction. The arc begins at the state from which the arc corresponding to the first term in the group originates. The arc terminates at the state at which the arc corresponding to the last term in the group terminates. Compound words and lexical phrases module 56 preferably uses a stored dictionary 29 containing such words and phrases along with their associated part of speech. An example of such a dictionary is provided as Appendix C in applicants' co-pending application (Ser. No. 09/084,535, filed May 26, 1998) entitled “Spelling and Grammar Checking System”. The contents of this application are incorporated herein by reference in their entirety. FSA 57, generated by compound words and lexical phrases module 56 is input to morphology module 58, which adds morphological analyses of each term to the FSA based on entries in a stored morphological dictionary 29. Such analyses preferably include, as a minimum, a part of speech for each term. Thus morphology module 58 adds an arc labeled with the appropriate part of speech for each term. In addition, the analyses may include an indication of the tense and/or the base form of a term. Morphology module 58 adds appropriate arcs to the FSA to represent each of these items. FSA 59, generated by morphology module 58, is then input to syntactic phrase module 60, which identifies phrases such as noun phrases, verb phrases, etc. that occur within the context and adds an appropriate arc for each phrase to the FSA. As described for arcs added by compound words and lexical phrases module 56, the arc begins at the state from which the arc corresponding to the first term in the group originates and terminates at the state at which the arc corresponding to the last term in the group terminates. FSA 61, generated by syntactic phrase module 60, includes arcs for category restrictions, compound words and lexical phrases, morphological restrictions, and syntactic restrictions satisfied by a term or group of terms in the context.

In summary, in embodiments of the invention in which a context is stored as an FSA, step 1340 preferably comprises the construction of the FSA by automaton generation module 52, category recognition module 54, compound words and lexical phrases module 56, morphology module 58, and syntactic phrase module 60. It is noted that the foregoing description is provided by way of illustration and is not intended to be limiting. Numerous variations on the foregoing are within the scope of the invention. For example, rather than generating new FSAs incorporating arcs for the various restrictions, modules 54, 56, 58, and 60 may instead modify the FSA generated by automaton generation module 52 to include the additional arcs. In addition, category recognition module 54, compound words and lexical phrases module 56, morphology module 58, and syntactic phrase module 60 can operate in any order, and any or all of the modules can be omitted entirely. As mentioned above, context indexer module 46 may store information about the context that may be used in assigning a score to a match that is located within the context. Such information may include features such as the position of the context within a document. In embodiments of the invention in which the contexts are represented as FSAs, such information is assigned to the FSA.

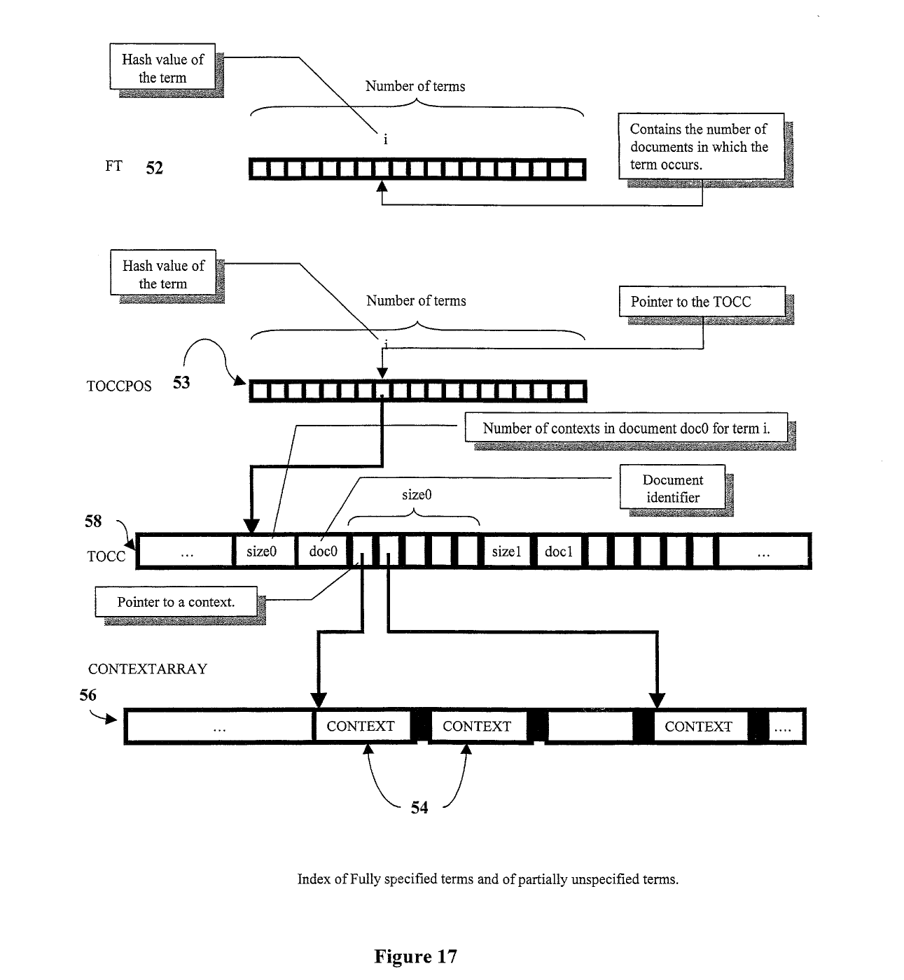

In a preferred embodiment, the information extracted by the indexing module is used in creating index data structures (52, 53, 56, and 58 as illustrated in FIG. 17) employed in finding contexts containing fully specified and partially specified portions of a query. For each word appearing in the documents, an array FT 52 is created with a number of entries corresponding to the number of key terms that appear in the documents plus the number of category restrictions the system is able to accommodate. To ensure a unique entry position for each term or category restriction, a term T is transformed into a unique numerical identifier i through the use of the hashing technique. Information relevant to term T, preferably the number of documents containing term T, is stored at location i in array FT 52. Thus when a term T is being processed, the location of indexed information for that term can be readily determined by obtaining the hashed value for T. In this regard it is noted that hashing techniques and algorithms have long been known in the art. For example, consider the query Senator_[NHUM] and suppose that the hashed value for the term Senator is 157. It is then known how many documents contain the term Senator by reviewing the contents of the 157^{th} entry in FT 52.

Another data structure created and used by the present invention is term array 53. Term array 53 contains the same number of entries as array FT 52 and is similarly accessed by hashing the term T and accessing the contents of the entry corresponding to the resulting hash value. The term array 53 contains context identifiers (or pointers) to positions in document array 58 corresponding to the beginning of information related to the term and contexts 54 for the term in as many documents in which the term appears. As shown in FIG. 17, at the i^{th} position in term array 53 is a pointer which points to entry size0 in document array 58. Size0 is an indication of the number of contexts 54 in which term T appears in a first document doc0. Also in document array 58 are document identifiers, such as doc0 and doc1, for the documents in which a given term T appears. Additionally, a number of pointers to context array 56 equal to the number of contexts 54 in a given document for a given term follow the document identifier. The context array 56 contains all the contexts 54 for each term found in the documents. The contents of each context array entry may be any representation of the context for the term, but as discussed is preferably a finite state machine. Within document array 58, sets of documents corresponding to a given term T are sorted by size, with smaller documents appearing in the array before larger documents. Also, sets of context identifiers (or pointers) corresponding to a given document are similarly arranged by size from smallest to largest. The significance of these sort orders to efficient searching and matching will be described below.

VII. Extended Matching Using Contexts

In order that the extended matching technique implementation may be better understood, the concept of contexts and their use in identifying matches, both of which are described in more detail in the Information Need application, are reviewed here with reference to FIG. 17. Briefly, a context 54 for a term T is a set of surrounding terms in which T appears, e.g., a character string including T. The context 54 can consist of a predetermined number of preceding and following terms including T, a sentence or paragraph containing T, etc. In the embodiments of the invention that utilize context-based searching, the invention stores a context array 56 that includes, for each term T, a set of contexts in which the term appears within documents. A document array 58 can optionally include identifiers for documents in which a context appears, an indication of the number of contexts for a given term in a given document, and pointers to the contexts 54 in the context array 56. When presented with a partially unspecified query, in those embodiments of the invention in which context-based matching is employed, the match engine locates matches that occur within contexts 54 rather than searching for matches within the documents themselves.

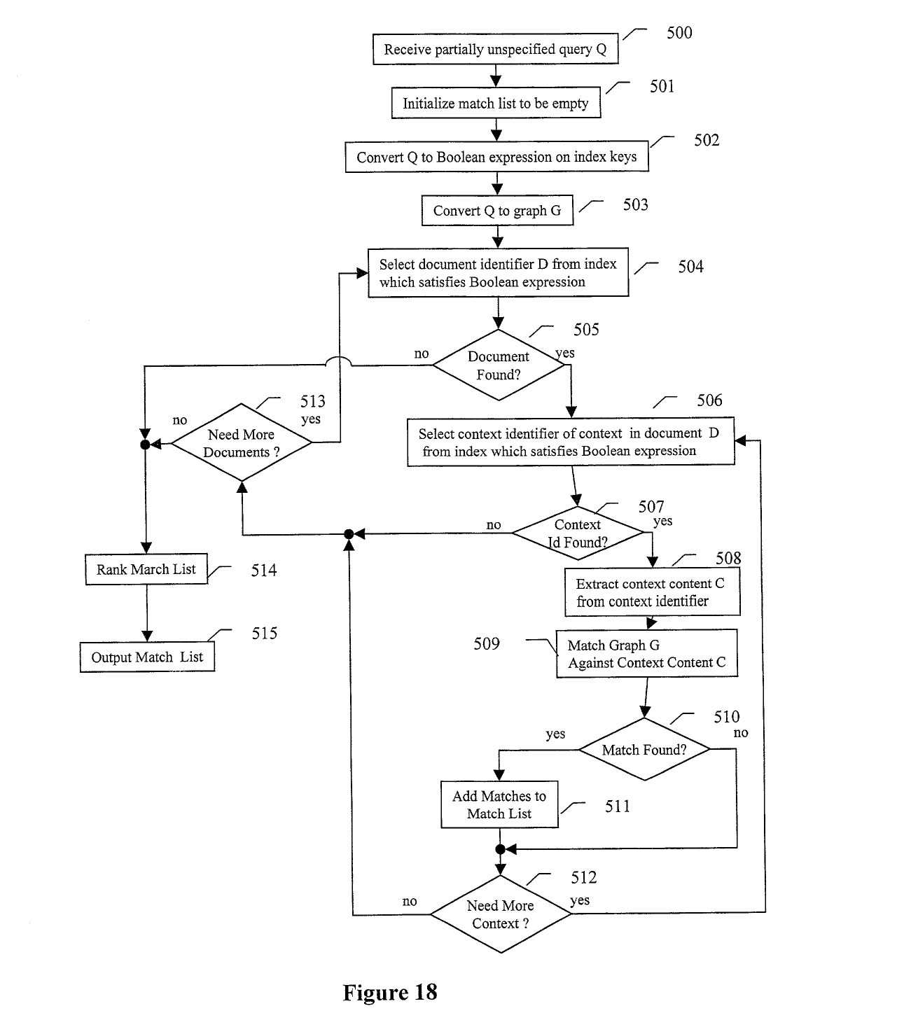

FIG. 18 illustrates the operation of match engine 34 and ranking module 36 in a preferred embodiment of the invention. As described in more detail below, match engine 34 generates a list of matches (match list) for the query. In this regard, it is noted that the use of the phrase “match list” to refer to the collection of identified matches (and possibly associated scores) is merely for descriptive purposes and is not intended to reflect the choice of any particular data structure. Instead, any convenient format may be used to store the identified matches, or the matches can be output as they are identified. Once the matching procedure is completed, the list of matches includes the instantiations of the partially unspecified query that match text in documents. Such a list of matches consists of sequences of words that realize the partially unspecified query, with information useful for ranking the sequences of words and/or the documents in which those sequences have been found.

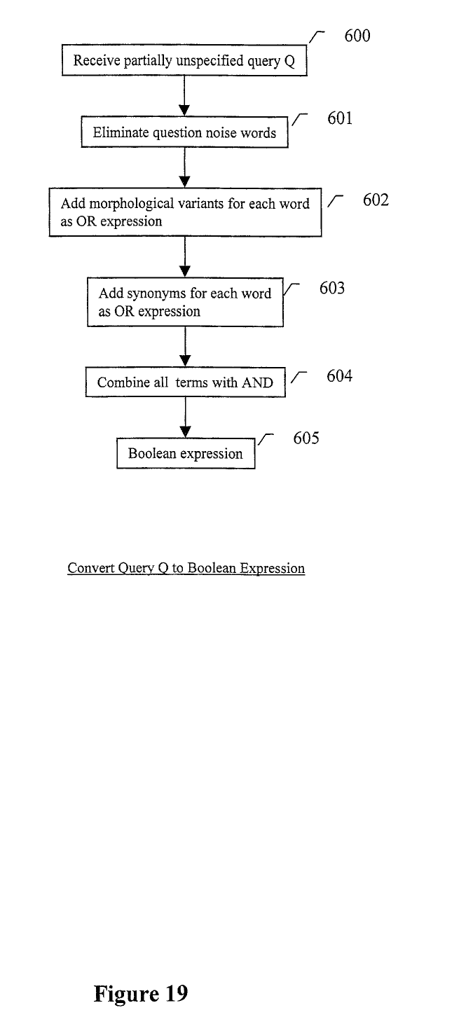

In step 500, match engine 34 receives a partially unspecified query Q. In step 501, the match list is initialized to be empty. In step 502, the partially unspecified query is converted by conventional means to a Boolean expression. FIG. 19 illustrates the process of converting the partially unspecified query into a Boolean expression. (For a discussion of Boolean processing, see Managing Gigabytes, Compressing and Indexing Documents and Images, Witten et al., 1994, Van Nortrand Reinhold, New York Chapter 4, section 4.3 and Boolean query processing, pages 136-141.) In step 600, the partially unspecified query is received. In step 601, “noise” words are eliminated from the query, noise words including determiners, articles, prepositions, and auxiliaries. For example, given the query_[WHO] invented the telephone, the word the would be eliminated at step 601 leaving_[WHO] invented telephone. In step 602, morphological variants for each term in the query is added as an OR expression. For the given example, this would yield_[WHO] (invent OR invents OR invented OR inventing) (telephone OR telephones). In step 603, synonyms for each term are added to the query as OR expressions. This expands the potential number of matches, as some synonyms may have a greater number of associated contexts than the original term. For the given example, this could add the morphological variants of the word discover, among others. In step 604, all the terms of the query are combined with an AND operator, and the resulting Boolean expression is returned to the matching process. For the given example, the resulting Boolean expression could appear as

_[WHO] AND (invent OR invents OR invented OR inventing OR discover OR discovers OR discovered OR discovering) AND (telephone OR telephones).

Returning to FIG. 18, in step 503, the partially unspecified query is converted to a graph G. It is in this conversion step that flexibility in extending matching is added with respect to order relaxation and allowance of intervening terms in potential matching contexts. As described in the Information Need application, in certain preferred embodiments of the invention the contexts are encoded using FSAs. In step 503, partially unspecified queries are preferably encoded using FSAs. In order to utilize the advantages inherent in the FSA implementation for the extended matching technique, queries are represented using the closely related concept of the finite state transducer (FST). Briefly, an FST is an FSA in which both an input (represented, for example, by a label above the arc) and an output are associated with each arc. In the present invention, for example, the output may be a weight or score that is associated with traversal of the arc. Thus when traversing between states of an FST the invention may maintain a cumulative score by adding the score associated with each arc that is traversed. An FST allowing traversal in any order between pairs of terms may be generated by assigning weights to flat graphs between permutations of pairs, then taking the union of the automata.

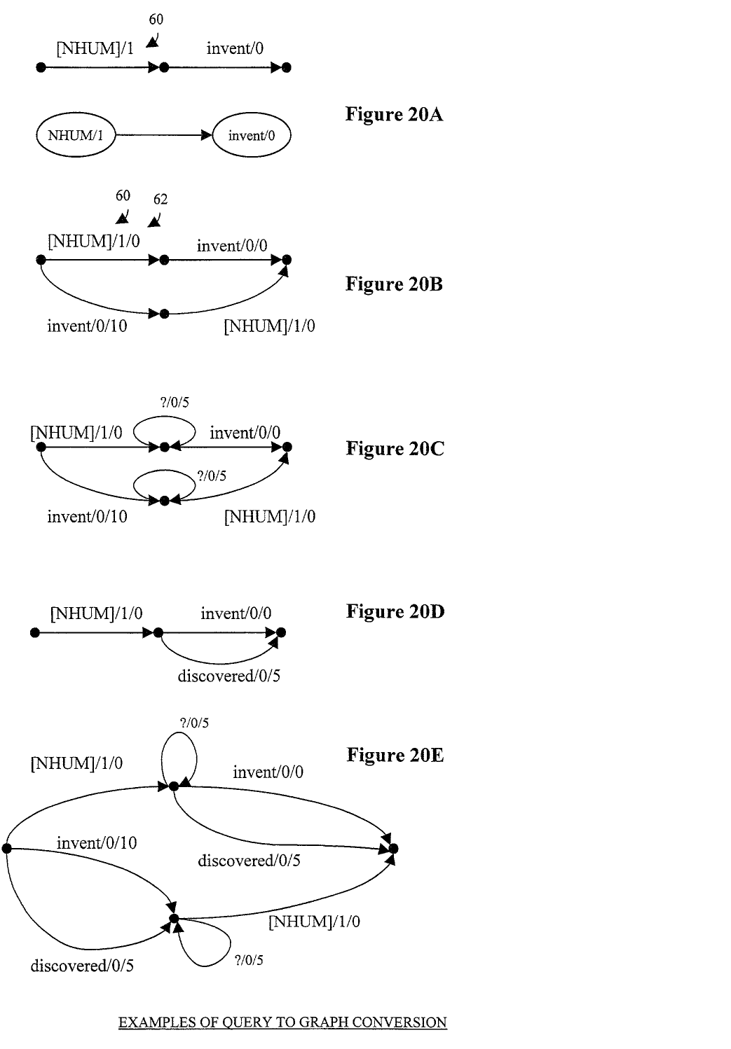

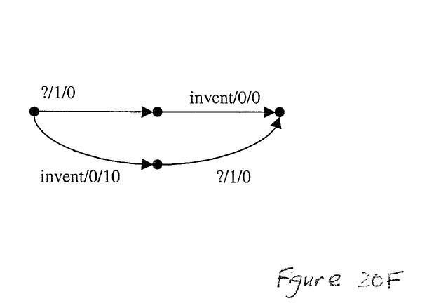

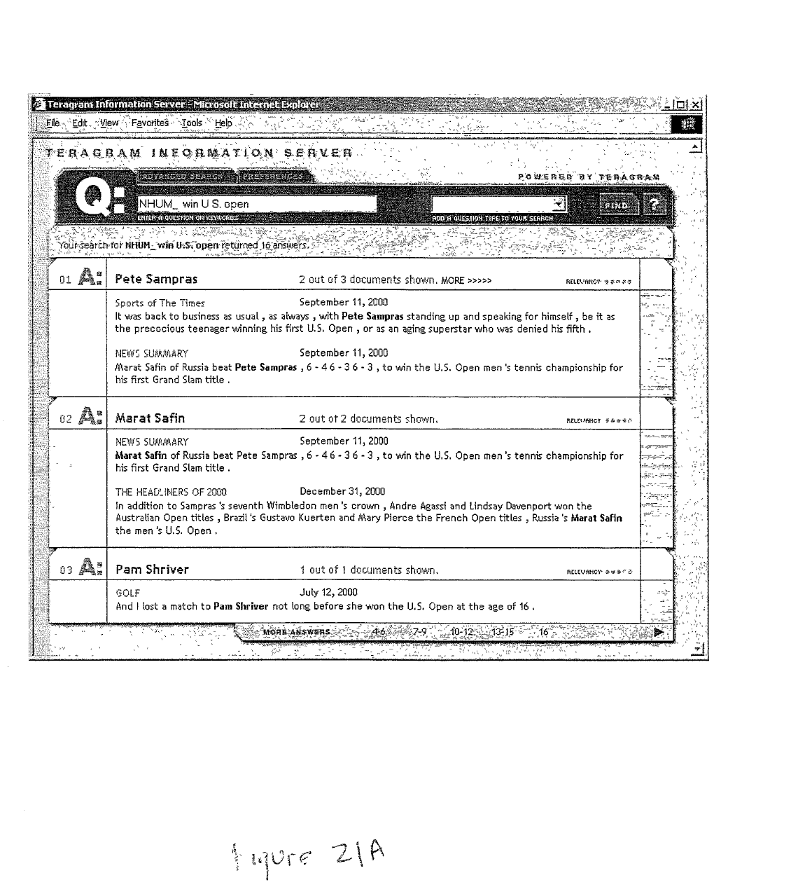

FIGS. 20A-F depicts numerous graphs illustrating different aspects of the present invention's flexibility, as compared with the Information Need invention. The figures are for exemplary purposes only and are not intended to indicate particular weights that must be assigned to arcs or any particular structure of the FST. Rather than representing a single order for a string as in the case of the FSAs presented in the Information Need application, an FSA or an FST may be used to represent all possible orders of the string. Note in FIG. 20A, which is an exact order finite state machine representation of partially unspecified query_[NHUM] invent, that transitions are pairs, wherein the first element is the term, and the second indicates whether the match ought to be collected (“1”) or not (“0”). Also note the equivalence between the Mealy and Moore representations of the finite state machine. In the Moore representation, outputs depend on the state of the state machine. In the Mealy representation, outputs depend on the state of the state machine and the inputs; the outputs are drawn with the inputs on the paths on the state diagrams. Furthermore, note that in representing contexts, as described in the Information Need application, the various restrictions satisfied by terms or groups of terms in the context are also represented by arcs in the FSA. (See, for example, FIGS. 14 and 15 in the Information Need application). Similarly, in representing queries, the restrictions satisfied by each term are also included as arcs in the FST in order that partially unspecified terms may match.

FIG. 20B illustrates an example of an FST in accordance with the present invention that represents all possible orders for the query_[NHUM] invent. Note that the transitions are triples, wherein the first element is again the term, the second element 60 the collection indicator, and the third element 62 in transition is a weight. Note that the arcs associated with the most similar order all have a weight of 0, and thus if the query represented by this FST operates on a context that includes a human name followed by the term invent, the score will be 0. However, if the query represented by this FST operates on a context that includes the term invent preceding a human name, the resulting score will be 10, indicating a permutation from the original order. Weights are summed in transition, with lower resulting weights indicating a greater likelihood that the context will accurately reflect the original order and fulfill the information need of the partially unspecified query. Adding a loop (arcs originating from and arriving at the same state) to this FST structure, as shown in FIG. 20C, allows for the appearance of any intervening words. The question mark matches any other word than the words on the outgoing edges. These loops can be assigned weights so that the overall score of a match found in a context in which there are many intervening terms between the terms appearing in the query will be assigned a higher score. Note that a numerical score is not required. For example, the output could be simply an indication of whether the order has or has not been permuted.

FIG. 20D illustrates a FST in accordance with the present invention that represents the query_[NHUM] invent with a synonym added. Again, arc weights are summed as an indicator of how close a potential matching context is to the initial partially unspecified query. FIG. 20E illustrates a FSA representing_[NHUM] invent and allowing terms to appear in any order and have intervening words. Finally, FIG. 20F depicts a FSA representing_invent which allows the term invent to be preceded or followed by any term, as represented by the question mark.

Return again to the embodiment of the extended matching process depicted in FIG. 18. In step 504 match engine 34 uses the data structures (52, 53, 56, 58 in FIG. 17) previously created through linguistically analyzing a collection of documents, and the Boolean expression constructed in step 502, to retrieve for some or preferably for each specified term and each fully or partially unspecified portion of the query, a document identifier from document array 58 that satisfies the Boolean expression. Using the data structures described earlier, a first document identifier for any given term T may be located by accessing the pointer to document array 58 contained in the entry of term array 53 corresponding to the hashed value of the term T, and subsequent document identifiers for the term T may be identified by knowing that documents in which term T appears are arranged in order (from smallest to largest) in document array 58, and discovering the number of documents in which term T appears. This information is contained in array FT 52 in the entry corresponding to the hashed value of term T. Note that fully specified terms will appear in a fewer number of documents. The present invention takes advantage of this fact by ordering the documents from smallest to largest in order that matching be conducted most efficiently. At decision step 505, if no such document identifier is found, match engine 34 proceeds to step 514.

If a document identifier satisfying the Boolean expression is found, match engine 34 proceeds to step 506. In step 506, match engine 34 attempts to identify a context identifier (or pointer) that satisfies the Boolean expression constructed in step 502. The context identifiers corresponding to term T in a given document D are similarly arranged in an increasing size order in document array 58. The number of context identifiers present for a term T in document D is also available in document array 58. For Boolean expressions containing an AND operator between terms, the match engine 34 attempts to select a context identifier corresponding to a context in context array 56 which contains preferably all the specified terms and fully or partially unspecified portions of the query. For Boolean expressions containing an OR operator between terms, all the context identifiers corresponding to the terms are identified as potential matching context identifiers.

For each selected context identifier, the match engine 34 checks that each fully specified term in the query appears in the context. Then the match engine determines whether the selected context contains a term (or group of terms) that matches a partially unspecified term in the query (i.e., a term satisfies the restriction associated with a partially unspecified term in the query.) In the case of partially ordered queries, the match engine additionally checks to make sure that the appropriate relative order is maintained. Note that for queries that contain more than one partially unspecified term this process must be performed for each term.

At decision step 507, match engine 34 determines whether a context identifier associated satisfying the Boolean expression has been found. If no such context identifier is found, match engine 34 proceeds to decision block 513 to determine whether additional documents are needed. If a context identifier is found, match engine 34 proceeds to step 508.

A simple example may be helpful. Consider the query Senator_[NHUM], and assume the hashed values for these terms are 157 and 160, respectively. In step 502 this query will be converted to Boolean expression Senator AND_[NHUM], ignoring for the moment for simplicity the plural form of Senator. Steps 504 through 508 operate to find contexts containing both terms in the same context in the same document. The 157^{th} entry of term array 53 will point to a position in document array 58 representing a first document in which Senator appears, and from the 157^{th} entry in array FT 52 it is known how many more documents following that first document may be identified as containing the term Senator. The term_[NHUM] is similarly processed. Suppose that it is determined that the terms appear in the following documents as follows:

| | |
|---|---|
| Senator | doc5, doc7, and doc8, |
| _[NHUM] | doc1, doc2, and doc7. |

Then, because the Boolean expression of this example involves an AND operation, match engine 34 seeks document identifiers associated with documents that contain both terms. Rather than intersecting the lists of document identifiers, the match engine 34 employs a comparison approach that leads to results faster and involves iteratively comparing individual document identifiers of the first list to document identifiers of the second list. Because of the arrangement of document identifiers in document array 58, certain comparisons may be effectively eliminated. Match engine 34 compares the first document identifier of Senator, doc5, sequentially to the document identifiers of _[NHUM]. Finding no matching document identifiers, match engine 34 need only compare the next document identifier of Senator, doc7, to document identifiers of _[NHUM] greater than or equal to doc5, and immediately finds a document identifier, doc7, satisfying the Boolean expression. Having found such a document identifier, match engine 34 proceeds to step 506 to attempt to find a context identifier of a context in doc7 which satisfies the Boolean expression. As described earlier, the number of context identifiers for each term in doc7 is stored in document array 58, and the context identifiers are sorted in ascending order. Suppose from document array 58 it is determined that the terms appear in the following contexts:

| | | |
|---|---|---|
| Senator | doc7 | contextID15, contextID20, |
| _[NHUM] | doc7 | contextID9, contextID20, contextID26. |

Then, a comparison approach is employed identical to that used in finding document identifiers to determine that context20 of doc7 satisfies the Boolean expression Senator AND_[NHUM] and should be passed on to step 508 for further processing. Although this example has been described with respect to a simple two term case, one skilled in the art can readily appreciate how the identification process may be extended to cases involving more than two terms.

In step 508, context content C associated with the found context identifier is extracted from the context array 56. In step 509, the FST constructed in step 503 representing the partially unspecified query is applied to the context content, which itself is preferably a finite state machine. At decision step 510, match engine 34 determines whether a match has been located. If not, processing proceeds to step 512. If, on the other hand, a match has been located then in step 511 match engine 34 accumulates information about the match and adds the match to the match list. Step 511 is discussed in more detail below. At this point it is noted that in addition to storing the matches, match engine 34 stores a score for each match, preferably as part of the match list.

At decision step 512, match engine 34 determines whether more contexts are needed. A variety of criteria may be employed to make this determination. Match engine 34 may consider the set of matches already located. For example, if match engine 34 has already located a particular match multiple times within document D (and especially if match engine 34 has not located any other distinct matches within document D), it may not be worthwhile to continue searching for matches within D. In such a case match engine 34 may determine at step 512 that no more contexts from document D are needed. Match engine 34 may also use information regarding the matches located thus far across a plurality of documents. For example, the total number of matches or the total number of different matches found thus far may be compared with a predetermined number or with a number selected by a user or may base the determination on the length of time already spent finding matches. Of course match engine 34 may use a combination of these or other methods to determine whether more contexts are needed. If match engine 34 determines that more contexts are needed, processing returns to step 506. Once all matches for the query within document D have been located or match engine 34 determines that no more contexts are needed, processing progresses to decision step 513.

At step 513, match engine 34 determines whether more documents need to be searched. As when deciding whether more matches are needed, a variety of criteria may be employed to determine whether more documents are needed. The determination may be based in part or entirely on the contents of the match list assembled thus far. For example, if the match list already contains a predetermined number of matches, match engine 34 may determine that no more documents need to be examined. Match engine 34 may also use information regarding the documents already searched for matches or the time spent searching. For example, it may be desirable to search a predetermined number of documents regardless of how many matches are already stored in the match list. If more documents are needed, processing returns to step 504, where another document containing potential matches for the query is selected as described above. If more documents are needed, match engine 34 resumes selecting document identifiers in step 504. In the example above, having found only one context identifier (doc20) for doc7 satisfying the Boolean expression, match engine 34 would then compare the next document identifier of term Senator, doc8, to doc7 of term_[NHUM].

Steps 505 through 513 are repeated until either no more documents and contexts containing potential matches are found or until no more documents and contexts are needed. In either case, match engine 34 proceeds to step 514. In step 514, ranking module 36 ranks the assembled match list. As described above, in preferred embodiments of the invention the match list includes a score for each match. In such a case, ranking module 36 may simply rank the matches based on the score. In other instances ranking module 36 may take additional information into account in assigning a ranking to the matches in the match list. If redundant matches have not been eliminated at an earlier step, this task may be performed in step 514. Preferably the matches are also placed in an order based on the ranking although ordering may be performed instead by results page generator 38. Following step 514, in step 515 match engine 34 outputs the match list. The output can be provided to results page generator 38, to another computer program, etc. It is noted that ranking is included in preferred embodiments of the invention, but it is not a requirement that the matches are ranked. Therefore ranking step 514 is optional.

Also optional are the steps of the matching process related to selecting document identifiers. Though it is preferred these steps be included because theyinerease the efficiency of the matching process by narrowing the corpus of documents whose context identifiers will be compared, the match engine 34 may operate directly upon the preanalyzed contexts stored in the data structures. FIG. 27 illustrates such an alternative matching process.

The process of adding a match to the match list (step 511) will now be discussed in greater detail. As mentioned above, in preferred embodiments of the invention, the match list includes a score for each of the matches listed therein. In one embodiment of the invention step 511 may simply add each newly located match to the match list, regardless of whether the identical match has been previously located and already appears in the match list, i.e., whether the newly identified match represents a distinct match that has not been previously identified or represents an instance of a match that has been previously identified. In such a case the score for the match may reflect factors such as the position and/or format of the match within a document. However, in preferred embodiments of the invention in step 511 match engine 34 determines whether a newly located match already appears in the match list and, if so, does not add another copy of the match to the match list. Instead, match engine 34 updates the score for the match to reflect the fact that the match has been located again. In such a case the score for a match reflects the number of times an instance of the match is located across a plurality of documents. Of course the score for the match may also reflect factors such as the position and/or format of the match within a document (e.g., whether the match appears in a title, in bold face, etc.). Features of the document in which a match is found such as the age or source of the document can also be used in assigning a score to the match. These factors may also be used in ranking the documents in which instances of a particular match are located, and in some embodiments of the invention match engine 34 maintains a document score for documents in which a match is identified.

Additional criteria may be used to determine the score for a match. In particular, in assigning a score match engine 34 may perform a normalization process based on the occurrence of particular words in the match across a plurality of documents in the database. The normalization process considers the frequency with which a portion of a match that matches the unspecified portion of the query occurs across a plurality of documents. If the portion of the match that matches the unspecified portion of the query occurs commonly, then it is relatively less likely that the match contains specific information relevant to the query. To provide an example, consider the query

_Windows

Phrases such as Microsoft Windows that include specific information related to Windows may appear very frequently within certain documents. However, in a large body of text with diverse content such as the set of Web pages, it is likely that phrases such as the windows, some windows, many windows, etc., will be more common. Since matches that contain common but information poor words such as the, some, etc. are relatively unlikely to contain desired information, the score for such matches should be low relative to the score for matches that do not contain such words. Normalization helps to ensure that this is the case. In a preferred embodiment of the invention match engine 34 normalizes the score by dividing it by a weighting factor that reflects the number of occurrences of the portion of the match that corresponds to the unspecified portion of the query among a plurality of documents. This information is available in the index of terms. For example, in the matches Microsoft Windows, the windows, and some windows, the words Microsoft, the, and some correspond to the unspecified portion of the query_Windows. During normalization, match engine 34 determines that Microsoft appears much less frequently among all the indexed documents than the common words the and some. Thus the weighting factor for Microsoft is much lower than the weighting factor for the other terms. Therefore, after dividing by the weighting factor the final score for Microsoft Windows will be greater than the score for the matches containing the common words. Different methods of performing normalization based on the occurrence of terms within the documents are also within the scope of the invention. Additional criteria such as the presence of certain terms whose co-occurrence is of particular significance can also be used to modify the score for a match.

Match engine 34 preferably keeps track of the number of instances of each distinct match within each document. Such information is stored and is used, for example, to rank the documents that contain the match as described in more detail below. This information can also be used in assigning a score to a match. For example, in certain embodiments of the invention one factor that is taken into consideration in assigning a score to a match is the relative distribution of instances of the match among documents. In particular, if instances of a match appear a large number of times within one or a few documents, the match may be less significant than if instances of the match appear within a large number of documents, even if the number of instances of the match within each of these documents is relatively small. For example, if a match appears 100,000 times within a single document, the match may be less significant than if the same match appears 5 times within 20,000 individual documents. Thus information accumulated about a match, such as the number of instances of the match within a document, may be used to assign or modify a score associated with the match in order to take such factors into account.

Of course, the score can also reflect factors such as the position and/or format of the match within a document or other information accumulated about the match. For example, when another instance of a match that already appears within the match list is located, the score for the match may be incremented by a certain amount A. If the newly located instance of the match occurs in boldface, the score may be incremented by an amount A+B. The score can also reflect features associated with the document in which a match appears. For example, the score may reflect such factors as the age of the document or the document's source. During the process of match acquisition, the match list may be maintained in an order based, for example, on the content of the matches or on their scores.

As described above, a match list entry for a query Q includes an entire string that matches Q along with an associated score for the match. However, in certain embodiments of the invention only that portion of a match that corresponds to the unspecified portion of the query is stored. In other words, match engine 34 extracts from a located match M that portion that corresponds to the unspecified portion and stores only that portion in the match list rather than storing the entire matching string. In this case for a query such as

_[CITY] is especially famous for its Gothic cathedral

the match list consists of those portions of the matching strings that satisfy the restriction [CITY], e.g., Chartres, Ulm, Cologne, Durham. Of course in preferred embodiments of the invention the match list also includes a score for each match reflecting the number of times the match is identified among a plurality of documents. Thus a match list for the query may appear as follows in schematic form:

{(Chartres, 125) (Ulm, 100) (Cologne, 75) (Durham 50)}

In addition, in the case of a query that contains multiple wholly or partially unspecified terms, it is possible that only a portion of a located match corresponding to one or more of the terms is of interest. For example, matches for the query

_[NAME] won_[NP] in the 1976 Olympics

might include Nadia Comaneci won several gold medals in the 1976 Olympics; Danielle Debernard won a bronze medal in women's alpine skiing in the 1976 Olympics; John Naber won five medals in swimming in the 1976 Olympics, etc. However, a user may be interested only in the names of athletes who won medals medal in the 1976 Olympics, rather than in the specific details. In such a case the portion of the query of interest indicated by ₁₃ [NAME] can be designated so that only the portion of a match that satisfies the restriction is added to the match list. Thus matches for the above query, assuming_[NAME] is the designated portion, would include Nadia Comaneci, Danielle Debernard, and John Naber among others. Note that the breadth of the restriction_[NP] allows the capture of a wide variety of matches since the phrases several gold medals, a bronze medal in women's alpine skiing, and five medals in swimming all satisfy the restriction [NP]. This breadth maximizes the use of available information. By permitting designation of only a portion of the query, the user's specific information need (the names of medal winners) can be optimally satisfied without providing additional, possibly unwanted, details. The portion of a query that is of particular interest can be designated in any of a number of ways. For example, a character such as a question mark can be used instead of an underscore character to designate wholly or partially unspecified terms of particular interest.

VIII. Ranking

As mentioned above, regardless of whether matches are located within documents or within contexts, match engine 34 assigns a score to each located match and adds the match to the match list. In certain embodiments of the invention the score is simply a running total of the number of occurrences of the match within the documents or context sets being searched. When match engine 34 encounters a match it searches the match list to determine whether that match has been previously added to the match list. If so, another copy of the match is not added to the match list but rather the score for the match is incremented. Thus, when the matching process is completed (e.g., when match engine 34 determines that sufficient matches have been found, that sufficient documents and/or contexts have been searched, or when all available documents or context sets have been searched) the score reflects the frequency of the match across a plurality of documents.

Ranking module 36 then uses the score to order the match list. In the simplest case, the ranking correlates directly with the score. In such a case the ranked match list may begin with the match with the highest score and progress to matches with lower scores. Thus a match that was located 500 times would appear before a match that was located 400 times, which would in turn appear before a match that was located 200 times. In certain embodiments of the invention the ranking is implicit in the order of the match list itself after the process of identifying matches is complete. For example, match engine 34 can reorder the match list on the fly, as new matches are identified or as additional instances of previously identified matches are identified. As mentioned above, traditional search and query systems locate documents that contain query term(s) and rank the documents based on the number of occurrences of the term(s) within the documents. In contrast, the present invention provides information (i.e., matches) that is relevant to a query rather than merely providing identifiers for documents that contain the query terms and thus may contain the desired information. Furthermore, in preferred embodiments of the invention the ranking of the matches reflects the occurrence of the information among a plurality of documents rather than within a single document. The ranking feature provides a basis on which the user and/or the system can assign a confidence level to the information. For example, consider the query Agatha Christie was born in_[NUM] discussed above. Assuming that the phrases Agatha Christie was born in 1890 and Agatha Christie was born in 1980 occur in documents in the database, both of these phrases (or both the numbers 1890 and 1980) will appear in the match list. However, in a database containing a large number of documents it is likely that the first phrase, expressing the correct information that Agatha Christie was born in 1890, will appear much more frequently than an incorrect phrase such as the second phrase. Thus the match containing the correct information will be ranked higher than matches containing the incorrect information. By ranking the matches based on their frequency among a plurality of documents, in cases such as this the invention permits a distinction between correct information and incorrect information. Of course, in many situations a variety of different phrases may contain correct and/or appropriate information. In some cases users may be particularly interested in rare or unusual matches. In addition, users may have an explicit interest in learning the order of the matches. For example, if the query_[NAME] is matched against a database consisting of Web pages, the query results would include an ordered list of the most popular or famous people mentioned on the Web.

IX. Results Page Generation and Output

After the match list is ranked (or without ranking in those embodiments of the invention that do not include ranking), it is passed to results page generator 38. The results page generator processes the results for display to a user or for input to another computer program. In those embodiments of the invention in which ranking is performed, matches are formatted and presented in an order corresponding to the ranked match list. Otherwise matches can be presented in any of a variety of orders. Information about the match such as the actual score and/or an indication of the frequency of the match relative to other matches is displayed in certain embodiments of the invention. As mentioned previously, in certain embodiments of the invention rather than displaying the complete match the system displays only that portion of a match that corresponds to one or more unspecified terms in the query. In certain embodiments of the invention results page generator 38 formats the results as a Web page for presentation by a Web browser.

In certain embodiments of the invention, in addition to the matches themselves, one or more document identifiers are displayed below or adjacent to the matches that occur within the documents. In the case of Web pages, the document identifier is preferably the URL of the Web page in which the match occurs. The URL may serve as a link to the Web page, thereby allowing the user to conveniently access the Web page if desired. Information about documents such as document language, age of the document, etc., may also be presented in the results. When document identifiers or other document-related information is included in results that are displayed to a user, preferably the document information is displayed adjacent to or below the match itself, so that the user may readily determine the identity of documents that contain a particular match. If the match occurs in more than one document, the set of documents that contain a particular match (or a portion of the set) can be displayed. The documents that contain a particular match are preferably displayed in an order corresponding to the number of instances of the match within the document. In other words, in addition to ranking the matches, the documents that contain a given match are themselves ranked. Thus for any given match, documents that contain a greater number of instances of the match are presented above documents that contain fewer instances of the match. The actual number of instances of a given match within a document can also be presented. As mentioned above, such information may be stored by match engine 34 during the process of match accumulation. Alternatively, this information may be obtained after the process of matching is complete, e.g., by ranking module 36 or results page generator 38. Of course other criteria such as the document's age or source, and/or the position or features of matches identified within the document can be used in addition to or instead of the number of matches identified within the document in order to rank the document. Preferably the documents are displayed in a format suggestive of a relationship between the documents and the match that they contain. For example, the documents may be listed beneath the match, adjacent to the match, or identified with an arrow or line extending from the match to the document list. In addition, in certain embodiments of the invention the results may include a fragment of text that includes the match and that also includes additional term(s) on either side of the match as they occur in a document that contains the match.

Instead of, or in addition to, presenting information that identifies documents containing a match, the invention may include information about the ranking of the match. For example, the results may include the number of documents in which the match was located, or a numerical score reflecting the relative level of confidence in the match versus other matches. Such information may help the user decide which, among multiple matches, may best fulfill the information need.

X. Summary

In summary, the extended matching techniques described herein, which implement unordered and partially ordered queries in addition to fully ordered queries, expand the range of options for identifying matches beyond those described in the Information Need application. It is to be understood that in general all the scoring and ranking tools, etc., described in that application are applicable here, in addition to others. Furthermore, the techniques described herein are applicable to queries generated in the course of answering natural language questions as described in the relevant application.

While the invention has been described and illustrated in connection with certain preferred embodiments, many variations and modifications as will be evident to those skilled in the art may be made therein without departing from the spirit of the invention, and the invention is thus not to be limited to the precise details of construction set forth above.

What is claimed is:

1. A method of fulfilling an information need employing an index stored on a computer-readable medium and comprised of preanalyzed contexts of terms appearing within a plurality of documents, comprising the steps of:
receiving a query comprised of one or more fully specified terms and an information need, wherein the information need is represented by one or more at least partially unspecified terms;
identifying contexts in the index that contain the one or more fully specified terms and zero or more at least partially unspecified terms; and
locating one or more matches for the information need within the identified contexts.

2. The method of claim 1, further comprising the step of:
identifying documents in the index that contain the one or more at least partially unspecified terms.

3. The method of claim 1, wherein the locating step further comprises:
converting the query into a finite state machine; and
matching the finite state machine against the identified contexts.

4. The method of claim 3, wherein the finite state machine is a finite state transducer.

5. The method of claim 3, wherein the finite state machine allows for the appearance of fully specified and at least partially unspecified terms in any order in a potential matching context.

6. The method of claim 3, wherein the finite state machine allows for one or more intervening words between the fully specified and at least partially unspecified terms in a potential matching context.

7. A method of fulfilling an information need employing an index stored on a computer-readable medium and comprised of preanalyzed contexts of terms appearing within a plurality of documents, information indicating category restrictions that the terms and contexts satisfy, and identifiers of the documents and contexts containing the terms, comprising the steps of:
receiving a query comprised of one or more fully specified terms and an information need and at least a partial restriction on the order that the one or more fully specified terms and the information need may appear in a potential matching context, wherein the information need is represented by one or more at least partially unspecified terms reflecting a category restriction;
identifying contexts in the index that contain the one or more fully specified terms and the one or more at least partially unspecified terms in the specified order;
locating one or matches for the information need within the identified contexts.

8. The method of claim 7, further comprising the step of:
identifying documents in the index that contain the one or more fully specified terms and the one or more at least partially unspecified terms in the specified order.

9. The method of claim 7, wherein the locating step further comprises:
converting the query into a finite state machine; and
matching the finite state machine against the identified contexts.

10. The method of claim 9, wherein the finite state machine is a finite state transducer.

11. The method of claim 9, wherein the finite state machine assigns a dissimilarity weight to appearances of fully specified and at least partially unspecified terms in potential matching contexts in orders other than that specified in the query.

12. The method of claim 9, wherein the finite state machine allows for one or more intervening words between the fully specified and at least partially unspecified terms in a potential matching context.

13. A method of fulfilling an information need employing an index stored on a computer-readable medium and comprised of preanalyzed contexts of terms appearing within a plurality of documents, comprising the steps of:
receiving a query comprised of one or more fully specified terms and an information need, wherein the information need is represented by one or more at least partially unspecified terms;
converting the query into a Boolean expression;
identifying contexts identifiers satisfying the Boolean expression; and
locating one or more matches for the information need within the identified contexts.

14. The method of claim 13, wherein the identifying step further comprises the steps of:
identifying document identifiers satisfying the Boolean expression.

15. The method of claim 1, 7 or 13, further comprising the steps of:
converting the query into a finite state machine; and
matching the finite state machine against the contents of the contexts associated with the identified context identifiers.

16. The method of claim 1, 7 or 13, wherein the contexts are stored as finite state machines.

17. The method of claim 1, 7 or 13, wherein the documents are accessible over the Internet.

18. The method of claim 1, 7 or 13, wherein the documents comprise World Wide Web pages.

19. The method of claim 1, 7 or 13, further comprising the step of:
accumulating information about the one or more matches as they are located.

20. The method of claim 1, further comprising the step of:
assigning a score to a match.

21. The method of claim 20, wherein the score reflects the number of times an instance of the match is located among the plurality of documents.

22. The method of claim 1, further comprising the step of:
outputting one or more of the matches, or a portion thereof, thereby providing a result for the query.

23. The method of claim 22, further comprising the step of:
outputting identifiers or locations of one or more of the documents that contains a match or portion thereof that was output in the outputting step.

24. The method of claim 23, wherein a location or a document comprises a uniform resourese locator.

25. The method of claim 23, further comprising the step of:
ranking the documents that contain a match, and wherein the second outputting step comprises outputting the document identifiers or locations of the documents that contain a match in an order based on the ranking.

26. The method of claim 25, wherein the ranking step comprises ranking a document based on the number of times a match is located within the document.

27. The method of claim 1, wherein the category restriction comprises a morphological feature.

28. The method of claim 1, wherein the category restriction comprises a syntactic feature.

29. The method of claim 1, wherein the category restriction comprises a computer program.

30. The method of claim 1, further comprising the step of:
storing a match or a portion thereof.

31. The method of claim 30, further comprising the step of:
storing a score for the match or portion thereof.

32. The method of claim 1, further comprising the step of:
storing a plurality of matches or portions thereof.

33. The method of claim 1, further comprising the step of:
storing a score for a plurality of matches or portions thereof.

34. The method of claim 1, wherein the index comprises locations of terms within documents.

35. The method of claim 34, wherein the locating step further comprises:
determining the location of a term in the query within a document using the index; and
locating a match for the query based on the location of the term within the document.

36. The method of claim 1, further comprising the step of:
ranking a plurality of the located matches or portions thereof.

37. The method of claim 36, wherein the ranking step comprises:
ranking a located match or a portion thereof based on the content of a plurality of documents identified in the identifying step.

38. The method of claim 36, wherein the ranking step comprises:
ranking a located match or a portion thereof based on the content of a majority of documents identified in the identifying step.

39. The method of claim 36, wherein the ranking is based on one or more features selected from the list consisting of: the location of a match within a document, a weight assigned to a document that contains a match, the age of a document that contains a match, the source of a document that contains a match, and a format feature of a match within a document.

40. The method of claim 36, wherein the ranking step comprises:
ranking a located match or a portion thereof based on the number of times an instance of the match is located within a plurality of documents identified in the identifying step.

41. The method of claim 36, wherein the ranking step comprises:
ranking a located match or a portion thereof based on the number of times an instance of the match is located within a majority of documents identified in the identifying step.

42. The method of claim 36, 38 or 39, further comprising the step of:
outputting one or more of the located matches, or one or more portions thereof, in an order based on the ranking, thereby providing a result for the query.

43. The method of claim 42, further comprising the step of:
outputting an indication of the ranking of a located match or portion thereof.

44. A method of fulfilling an information need based on documents stored on a computer-readable medium comprising the steps of:
storing an index identifying documents containing terms;
storing contexts for terms, wherein a context occurs in a document;
receiving a query containing an unspecified portion; and
identifying one or more matches for the query within the contexts.

45. A method of fulfilling an information need based on documents stored on a computer-readable medium comprising the steps of:
storing an index identifying documents containing terms;
storing contexts, wherein a context occurs in a document;
storing information to retrieve a list of contexts for terms;
receiving a query containing an at least partially unspecified portion; and
identifying one or more matches for the query within the contexts.

46. The method of claim 45, wherein contexts are preanalyzed.

47. A method of fulfilling an information need based on documents and an index stored on a computer-readable medium comprising the steps of:
storing contexts for terms, wherein the context occurs in a document;
storing information identifying a document in which a context occurs;
receiving a query containing an unspecified portion; and
identifying a plurality of matches for the query within the contexts.48. A method of generating an index for satisfying an information need from a

48. A method of generating an index for satisfying an information need from a plurality of document stored on a computer-readable medium, comprising the steps of:
receiving a document;
identifying a context in the document;
linguistically analyzing the context;selecting a term from the document;
determining if there are more terms in the context to select, and if so,
selecting another term from the context until there are no more terms to select;
determining if there are more contexts to identify in the document, and if so, identifying another context in the document and repeating the term selecting step for each term in the context until there are no more contexts to identify;
determining if there are more documents to receive, and if so, receiving the next document and repeating the context identifying and term selecting steps until there are no more documents to receive.

49. The method of claim 48, wherein linguistically analyzing the one or more contexts further comprises identifying category restrictions satisfied by the context.

50. The method of claim 48, further comprising the step of:
storing information indicating the number of contexts stored for a term in a document, a document identifier associated with the document, and context identifiers indicating the location of the one or more contexts stored in the context array.

51. The method of claim 48, wherein the analyzed contexts are stored as finite state machines.

52. The method of claim 48, wherein the analyzed contexts are stored as graphs.

53. The method of claim 48, wherein the analyzed contexts are stored as trees.

54. The method of claim 48, wherein the category restrictions comprise morphological features.

55. The method of claim 48, wherein the category restrictions comprise syntactic features.

56. The method of claim 48, wherein the category restrictions comprise computer programs.

57. An apparatus for fulfilling an information need employing an index stored on a computer-readable medium and comprised of preanalyzed contexts of terms appearing within a plurality of documents and information indicating category restrictions that the terms and contexts satisfy, comprising:
memory means that stores computer-executable process steps; and
a processor that executes the process steps so as to (i)receive a query comprised of one or more fully specified terms and an information need,
wherein the information need is represented by one or more at least partially unspecified terms reflecting a category restriction; (ii) identify preanalyzed contexts in the index that contain the one or more fully specified terms and the one or more at least partially unspecified terms; and (iii) locate one or matches for the information need within the identified preanalyzed contexts.

58. An apparatus for fulfilling an information need employing an index stored on a computer-readable medium and comprised of preanalyzed contexts of terms appearing within a plurality of documents, information indicating category restrictions that the terms and contexts satisfy, and identifiers of the documents and contexts containing the terms, comprising:
memory means that stores computer-executable process steps; and
a processor that executes the process steps so as to (i) receive a query comprised of one or more fully specified terms and an information need and at least a partial restriction on the order that the one or more fully specified terms and the information need may appear in a potential matching preanalyzed context, wherein the information need is represented by one or more at least partially unspecified terms reflecting a category restriction; (ii) identify preanalyzed contexts in the index that contain the one or more fully specified terms and the one or more at least partially unspecified terms in the specified order; and (iii) locate one or matches for the information need within the identified preanalyzed contexts.

59. An apparatus for fulfilling an information need employing an index stored on a computer-readable medium and comprised of preanalyzed contexts of terms appearing within a plurality of documents, information indicating category restrictions that the terms and contexts satisfy, and identifiers of the documents and contexts containing the terms, comprising:
memory means that stores computer-executable process steps; and
a processor that executes the process steps so as to (i) receive a query comprised of one or more fully specified terms and an information need and at least a partial restriction on the order that the one or more fully specified terms and the information need may appear in a potential matching preanalyzed context, wherein the information need is represented by one or more at least partially unspecified terms reflecting a category restriction; (ii) identify preanalyzed contexts and documents in the index that contain the one or more fully specified terms and the one or more at least partially unspecified terms in the specified order by converting the query into a Boolean expression and identifying context identifiers satisfying the Boolean expression; and (iii) locate one or matches for the information need within the identified preanalyzed contexts by converting the query into a finite state machine and matching the finite state machine against the identified preanalyzed contexts.

60. Computer-executable process steps stored on a computer-readable medium, the computer-executable process steps to fulfill an information need, the computer-executable process steps comprising:
code to receive a query containing an unspecified portion, the unspecified portion including an unspecified term; and
code to identify one or more matches for the query within a body of information stored on a computer-readable medium.

61. Computer-executable process steps stored on a computer-readable medium, the computer-executable process steps to fulfill an information need, the computer-executable process steps comprising:
code to store contexts for terms, wherein a context occurs in a document,
code to store information identifying a document in which a context occurs;
code to receive a query containing an unspecified portion; and
code to identify one or more matches for the query within the contexts.

62. Computer-executable process steps stored on a computer-readable medium, the computer-executable process steps to fulfill an information need, the computer-executable process steps comprising:
code to identify a plurality of matches for a partially unspecified query; and
code to rank a plurality of the matches or portions thereof.

63. Computer-executable process steps stored on a computer-readable medium, the computer-executable process steps to fulfill an information need, the computer-executable process steps comprising:
code to identify a plurality of results for a query, the results occurring within documents; and
code to rank the plurality of results based on the content of a plurality of documents in which a result is identified.
